(19) United States
(12) Patent Application Publication
(10) Pub. No.: US 2009/0034786 A1
(43) Pub. Date: Feb. 5, 2009

(54) Application for Non-Display of Images Having Adverse Content Categorizations

(76) Inventors: Steven P. Newell, Mapleton, UT (US); Ralph J. Yarro, III, Provo, UT (US); Glenn A. Bullock, Pleasant Grove, UT (US); Matthew Yarro, Lindon, UT (US); Justin C. Yarro, Provo, UT (US); Benjamin J. Bush, West Jordan, UT (US); Allan C. Smart, Orem, UT (US)

Correspondence Address: EVERETT D. ROBINSON;Echelon IP, LLC, P.O. Box 1047, American Fork, UT, 84003-1047, US

(21) Appl. No.: 12/131,670

(22) Filed: Jun. 2, 2008

Related U.S. Application Data
(60) Provisional application No. 60/932,926, filed on Jun. 2, 2007.

(51) Int. Cl. G06K 9/00

(52) U.S. Cl. 382/100

(57) ABSTRACT

Disclosed herein are databases that contain image context categorizations, those categorizations identifying the context of an image based on a computed fingerprint. Also disclosed herein are applications of such a database, including a viewing application that blocks the rendering of images with undesirable content noted by a content categorization, and a scanning application that locates images in a corpus or repository of images having certain content noted by content categorization, such as unlawful images. Such blocking may be through an obfuscation technique, such as blurring, distorting an image, or may be through a replacement of image material. A categorization tool may include obfuscation with an aperture tool for clarifying portions of blocked images. Detailed information on various example embodiments of the inventions are provided in the Detailed Description below, and the inventions are defined by the appended claims.

### CROSS REFERENCE TO RELATED APPLICATIONS

This Application claims the benefit of U.S. Provisional Application No. 60/932,926 filed on Jun. 2, 2007 which is hereby incorporated by reference in its entirety.

### BACKGROUND

The claimed systems and methods relate generally to image identification, tracking and filtering, and more particularly to systems that can autonomously identify the content of an image based on a prior categorization using an image identification.

### BRIEF SUMMARY

Disclosed herein are databases that contain image context categorizations, those categorizations identifying the context of an image based on a computed fingerprint. Also disclosed herein are applications of such a database, including a viewing application that blocks the rendering of images with undesirable content noted by a content categorization, and a scanning application that locates images in a corpus or repository of images having certain content noted by content categorization, such as unlawful images. Such blocking may be through an obfuscation technique, such as blurring, distorting an image, or may be through a replacement of image material. A categorization tool may include obfuscation with an aperture tool for clarifying portions of blocked images. Detailed information on various example embodiments of the inventions are provided in the Detailed Description below, and the inventions are defined by the appended claims.

### BRIEF DESCRIPTION OF THE DRAWINGS

FIG. 1 depicts the components of a viewing application that uses an image characterization database.

FIG. 2 depicts a complex characterization tuple.

FIG. 3 depicts a method of displaying images based on preformed content categorizations.

FIG. 4 depicts the components of a scanning application that uses an image characterization database.

FIG. 5 depicts a method of scanning images and entering content categorizations into a database.

FIGS. 6A through 6K show screenshots from an exemplary scanning application.

FIGS. 7A and 7B show a report generated from the exemplary scanning application.

Reference will now be made in detail to particular implementations of the various inventions described herein in their various aspects, examples of which are illustrated in the accompanying drawings and in the detailed description below.

### DETAILED DESCRIPTION

A discussion of certain products, systems, methods and principles is now undertaken for the purpose of disclosing and enabling one of ordinary skill in the art to make and use the inventions. The discussion of particular of these is merely for convenience, and it is to be understood that certain substitutions and modifications may be made to the products and systems described herein without departing from the disclosed and claimed inventions. For example, in today's signal processing equipment an audio signal may be represented as a stream of audio data, and these are synonymous herein to their respective analog and digital domains. Likewise, where an implementation is described as hardware, it can usually be made with software components, and vice versa. Similarly, where an application is referenced, that can be a stand-alone application or a plug-in to an existing one. Where an invention is described with reference to any particular implementation, it is to be understood that this is merely for convenience of description and the inventions so described are not limited to the implementations contained herein.

The systems and methods disclosed herein relate to the categorization of images with respect to their content. Other systems have attempted to categorize material publicly available over the Internet, mainly by categorizing websites or IP addresses as containing material that is potentially offensive, unsuitable for children, containing viruses, etc. These systems maintain a list of URLs and/or IP addresses considered to be offensive. These systems may also look at the textual material available on a website, and flag that website as problematic if it contains certain words or phrases in sufficient frequency. As will become apparent from the discussion below, the systems and methods disclosed herein do not necessarily utilize URLs, IP addresses or other locational identifiers but rather use a fingerprint calculated from the informational content of an image.

Law enforcement agencies are tasked with analyzing large quantities of electronic data in an attempt to prosecute electronic crimes, such as the distribution of child pornography. At the present time, agencies may perform image analysis through a brute-force visual inspection of images located on media, for example a hard drive seized from a potential wrong-doer. Using systems as described herein, law enforcement agencies may collaborate, sharing content categorization information thus providing an automatic detection mechanism that can be used as new media devices are seized, recognizing that illicit images are often passed unmodified between criminals and are likely to be recurringly found. Contemplated in the invention is a master law enforcement database that is accessible to several law enforcement agencies using a common image fingerprinting scheme, optionally using a common scanning and/or viewing program or a common protocol.

Also contemplated herein is a public content categorizations database that may be used by the general public. The content categorizations in the database might come from trusted sources, for example a law enforcement database or one from a trusted public service organization. In other instances content categorizations may originate from untrusted sources, and a method of evaluating a confidence of trust may be provided. An application, such as a scanner or viewer, may be provided to the public capable of accessing a public database over a network, or alternatively by a corresponding content categorization database on a fixed media such as DVD media or on a portable hard drive. Such an application may be useful to a parent to ensure that her children are not exposed to inappropriate material. Such a product may also be useful to business organizations that wish to ensure that their networks and computer equipment remain free of offensive or illegal visual material. Such an application might also be useful for libraries or educational use to detect and/or prevent those who use public terminals from accessing improper material.

As used herein, a fingerprint means the output of any function that can be applied to an image, where the output is consistent for the same image data and where the output is much smaller than the image itself. Conceptually, this kind of fingerprint is related to a human fingerprint that is small and can be used to substantially uniquely identify a person. For example, it is known to save a fingerprint as digital data which may be an image of the fingerprint itself or a set of data representing the position of various fingerprint features. A suitable fingerprint function for images will produce a set of fingerprints, each of which is substantially unique for each of the images expected to be encountered. For example, it may be that for the next 50 years a number of images available on the Internet might be expected to be 100 trillion. If the fingerprint-producing function was a hash function, then a function that produces a word of 64 bits would produce a set of fingerprints that is less than 0.000001% likely to be duplicated, provided that the fingerprint function has a good statistical distribution.

A suitable fingerprint function will meet two goals. First, images are condensed into an identifier based on their content, which identifier is comparatively small and suitable for storage and communication between processes. Second, the identifier or fingerprint is a non-visual representation, i.e. looking at the fingerprint does not expose the viewer to the undesirable visual effects of the offensive image. Thus, a hash value of image data would be typical of a fingerprint as disclosed herein, although other extractions may be used; however thumbnail images and other degraded visual depictions are not fingerprints.

Advantageously a fingerprint function may be selected having immunity to modifications of an image. Noise may be introduced by lossy compression of images, for example through the use of the JPEG image format. Noise might also be deliberately introduced by parties wishing to encode additional data in an image (sometimes called stenography) or to circumvent a fingerprint function for the purpose of avoiding an adverse categorization of an image. In one example, a fingerprint function ignores the least significant bits of image data that are most likely to be changed by a compression algorithm, or alternatively the function may consider the most significant perceptual bits of image data where changing the data would likely be noticed by a viewer. In another example, a fingerprint function may apply a median function to avoid an intentional introduction of random white or black pixels in an attempt of circumvention. An image might also be cropped or put in a frame to cause an image to have a different fingerprint. A fingerprint generator may be configured to use only a portion of the image, such as the center portion or that portion representing a dispersal pattern, or alternatively a fingerprint generator may be configured to generate several fingerprints on different portions of the input image. Other anti-circumvention techniques may be used.

The definition of what sort of material constitutes that which should be categorized in a particular category may vary between categorical schemes, applications of use and persons. For example, there may be a particular and precise legal definition for child pornography for which one may become criminally liable for the creation or distribution of such. However, in other cases categories may be created for the protection of certain individuals against harmful or offensive material. For example, it may be desired to protect children from the exposure of certain material that is sexually explicit or violent in nature. A category may be created for sexually explicit material, and another category may be created for that which is violent in nature. The reader will recognize that such categories cannot be precisely defined, because one person's concept of material that is unsuitable for children will differ from that of another. Furthermore, the application of use may dictate a more lenient or a more strict standard. Thus, a picture used in a medical setting may be appropriate even though it depicts nudity, while another picture depicting the same bodily location may be offensive if cast in a sexually suggestive way. Alternatively, a category may be defined that encompasses several subcategories, such as a category that defines material that is unsuitable for children under a particular age regardless of whether it is sexual or violent in nature. A category may also be created for material that a user does not wish to be exposed to, even if he would suffer no ill effect from it. One categorical scheme provides categories for indecent, violent, obscene and illegal images. Another categorical scheme, suitable for law enforcement, uses the categories of illegal and legal. A category may also be created for images that are safe, which may mean images that do not fall under another category.

To be most effective, a collection of image fingerprints may be made accessible in a database, each fingerprint being stored with a content categorization. The disclosure below will provide several examples of creating and using such a database, but a few remarks are in order. First, a database may be simply an unstructured list of fingerprint/categorization combinations. However, it is preferable to organize a database in a way that makes it indexable, for example by ordering the fingerprints in ascending or descending order, or alternately in a tree or other organized structure. This would be a good format for fixed database, i.e. one that is permanent and read-only such as a non-network distributed copy. Alternatively, where a database is to be created or changed, it may be preferable for the database to exist in an autonomously indexable format such as in a relational database or hash table. However, these are not required and any database format may be used that meets the desired criteria of use.

Image Viewing Applications

The number of viewing applications for which a content categorization database can be used are many; virtually any software application capable of displaying images not preselected by the developer can benefit. Some of these applications are, but are not limited to, web browsers, e-mail programs, instant messengers, image display and printing applications, image preview applications, video players, word processors, greeting card programs and many others. Although herein is contemplated that most application functionality will be constructed in software, it should be recognized that a graphics card or other hardware device might be constructed implementing the fingerprint generator, image blocking or other functionality described below.

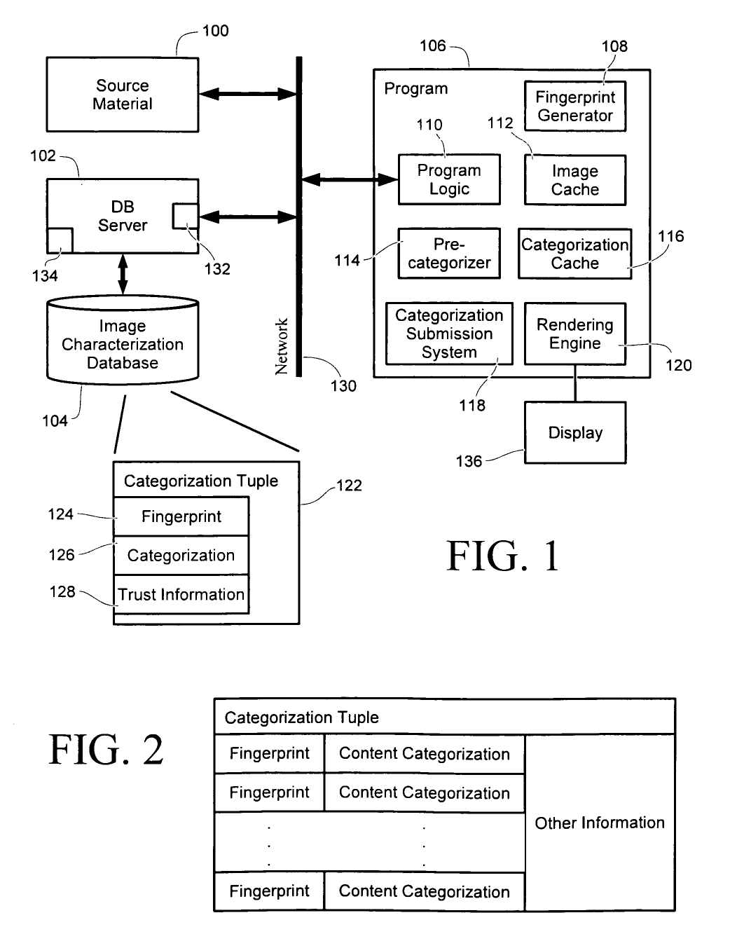

For the purposes of presenting an example, an HTML browser application is presented in FIG. 1. There, a collection of source material 100 is made available over a network 130 to an HTML browser program 106. The source material 100 may contain HTML, images, scripts, plug-ins and other material. The program 106 includes ordinary functional modules including program logic 110 containing software running overall or generic programming functions, a rendering engine 120 for displaying images received through network 130 and, in this example, an image cache 112 that provides a temporary cache of images to avoid repeated downloading of them.

Program 106 may access an image characterization database 104 through database server 102, made available over network 130 by a network port 132. Database 104, in this example, is a community resource made available to a number of programs, platforms and locations. Server 102 has a program store 134 containing server software. Database 104 stores a set of categorization tuples 122, which tuples include a fingerprint 124 and a categorization 126. Trust information 128 may also be included in the tuple 122, as will be described below.

In the course of rendering an HTML page, program logic 110 at some time may interpret HTML code that will link to an image located within source material 100 or other location. Program logic 110 typically downloads such images and places them in cache 112. Optional subpart precategorizer 114 may filter out those images that are not likely to fall within the category. For example, many images available on the Web are logos, separators, simple backgrounds, etc. Precategorizer 114 may operate to analyze the complexity within images to identify those images that do not need to be fingerprinted and checked for categorization, for example through the use of frequency analysis, color histograms, flesh tone analysis and shape recognition.

For those images needing to be evaluated, fingerprint generator 108 produces a fingerprint. That fingerprint is passed by program logic 110 in a request to database server 102 for its categorization. Database server 102 consults database 104, and reports back information including at least one categorization 126. Other information may be included as well, for example where more than one categorization is needed or where trust information is to be evaluated by the application 106. Upon receipt of a categorization 126 program logic 110 stores it in categorization cache 116. Program logic 110 may then evaluate the returned categorization for an image and may cause the image to be rendered by engine 120 on display 136 if the returned categorization indicates that the image is suitable to render. This suitability may be determined by the absence of a negative categorization, or by the indication of a positive categorization such as “safe”.

However, it may be that there is no categorization within database 104 for a particular image fingerprint. In that event, server 102 may report no entry, and program logic may apply a default action. In one example, the default action is to render the image. This action may be preferable under ordinary conditions, as no image characterization database is likely to be complete or current and an occasional image that would be categorized negatively will not impact the user unduly. In another example, the default action is to not render the image. This action may be preferable where the program is to be used in a sensitive environment such as an elementary school or library. Other examples may segregate areas of the Web for either action, for example by allowing images to be rendered from websites that end in .gov but not rendering images with no characterization from websites that end in .net.

Now referring to FIG. 2, a context characterization tuple is displayed having a number of exemplary informational items. While the tuple of FIG. 1 contained only one fingerprint, this tuple includes more than one fingerprint, for example where more than one fingerprint generator algorithm is used or where a set of fingerprints are generated from different image locations. This tuple provides for more than one characterization, for example where more than one characterization topic (i.e. sexual content, violence, nudity, child pornography, etc.) or more than one characterization scheme (i.e. scheme for a young child, scheme for an older child, scheme for a public computer, scheme for law enforcement, etc.) is used. For the context characterization tuples disclosed herein, a relationship must exist between a fingerprint and a categorization.

This exemplary tuple also includes a part for other information that may be helpful to the context characterization. This other information may contain further information about the location or the locations an image fingerprint has been found, such as the URL or domain name of the location. The location information may have been submitted at the time the image indexed by the fingerprint was submitted for categorization into a database. In one example where location information is used, upon a request for categorization to a server of a characterization database, the server not only returns the categorization of the submitted image fingerprint but also the categorization of other related fingerprints at or near the same network location. Program logic may cache these fingerprints for further reference, and should a fingerprint be present in the cache a request to server need not be performed.

Optionally, an application may submit a location of the image for which a characterization is requested to a server. Because the network traffic cost of sending a packet containing only a single image categorization is comparatively small, it may be that the actual packet that is transmitted across the network is padded to meet a minimum packet size. By packing more information that is likely to be needed into a first packet subsequent requests may be avoided, improving the response of the system, and furthermore network traffic load may be improved. The amount of related categorizations to return may be selected to fit a minimum packet size, from a pattern of earlier categorization requests, from an analysis of the links at the location, or other method. In an alternative method, location information is not stored in a characterization database but in a separate database wherein is maintained related links and fingerprints indexed by a location or a fingerprint.

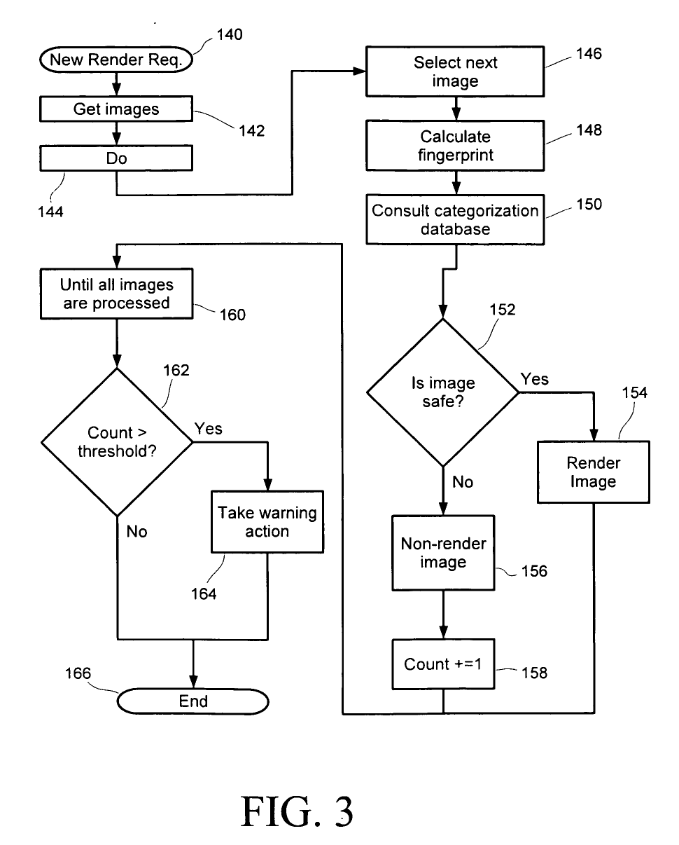

Now turning to FIG. 3, the method is shown for an application that may display images using preformed content categorizations. Beginning with step 140, the method is initiated when a request is made to render a screen that contains one or more images. The images are fetched 142 and the method iterates through the images obtained between steps 144 and 160. The next image is selected 146 and a fingerprint is calculated for it 148. The categorization database is consulted 150, and the method questions 152 whether the image is safe to display. If yes, the method renders the image 154. Otherwise the image is non-rendered 156. The non-rendering of an image may include replacing the image with another image, a solid background, a message warning of disallowed content, an obfuscated image made through blurring or other distortion, or some other replacement object. In this method account is maintained to indicate the ‘badness’ of a particular screen or page by counting the number of disallowed images, by which a counter is incremented 150. In this method the counter is compared against a threshold 162 and should the counter be too high, indicating that there is too much disallowed material, a warning action may be taken 164. Such a warning action may be a simple warning to the user to indicate why many of the images were not rendered. Another action might be to block the entire contents of a webpage, including the text, on an assumption that explicit text often accompanies explicit images. A stronger action can be taken, such as scolding the user for accessing an illicit location. In an alternative method, as the loop iterates the counter is compared against a threshold and should it exceed the threshold the loop exits and an action may optionally be taken.

Database Population

As discussed above, an application can be constructed the references a database of content characterization information. That kind of application relies on those characterizations being available at runtime, provided to the database at an earlier time. There are two basic ways of populating a characterization database, which are referred to herein as scanning and interaction. The interaction method is built into an image-rendering application that uses the database, providing a way for the user to submit image characterization information to the database. For example, the system of FIG. 1 includes a categorization submission system 118 allowing program logic 110 to provide a fingerprint/categorization relationship to database server 102, and thereby to database 104, upon user request. For example, an application may permit the user to right click on an image and bring up a menu that includes an item to submit a categorization of that image to the database 104. Selecting that item presents the user with a form or questionnaire to indicate which categories are appropriate, i.e. sexual, nudity, violence, safe etc. Other applications may include an option to submit an image categorization in accordance with the design of the application and the appropriate database.

In a viewing application or a scanning application obfuscation may be used to avoid exposure to user of material that is potentially offensive or has been categorized as such. For a viewing application the decision of whether or not to obfuscate may be determined by whether an image has a negative characterization, or alternatively whether the image has been previously categorized as safe. For a scanning application it may be desirable to obfuscate all images initially, or to use a pre-categorization filter to select images that are potentially offensive. For example, a pre-categorization filter may flag images that are monochrome or have insufficient complexity to display without obfuscation. In examples presented herein, the method of obfuscation is to blur the image sufficiently such that only the higher-level details can be seen, i.e. to the degree that a person can identify roughly people or bodies in an image while not being able to discern specific features. Note, however, that the level of obfuscation or blur that is comfortable may vary from user to user, and a user control for such a default level may be included. Other methods of obfuscation include scattering, applying a lensing effect, degrading the resolution of the image, and many others.

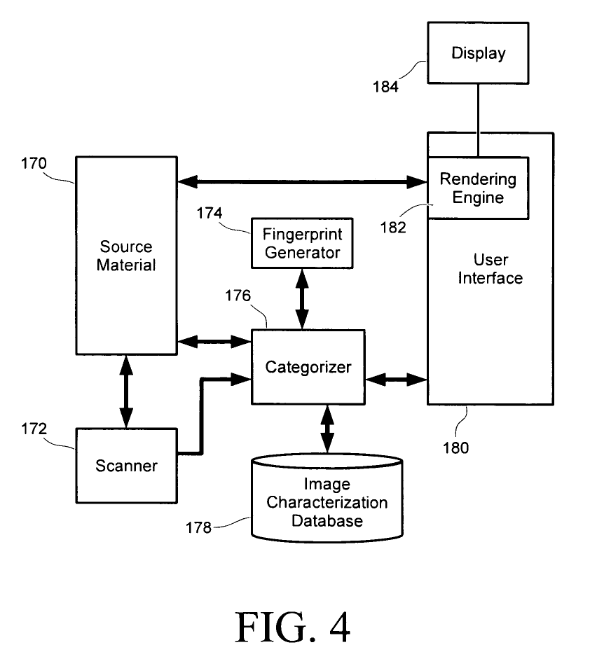

Now turning to FIG. 4, an image scanning system is presented. Again the primary purpose of a scanning system is to assign to or review categorizations of images, although it may also have the ability to present and display images to the user in a rendered format like a viewing application. A scanner needs a repository of source material 170, which may be a directory on the local drive, a directory on a network drive, an HTTP address or other repository whereby images may be found. A scanner 172 examines repository 170 identifying the locations of images, which are provided to categorizer 176, for example in a list of locations. For image locations, categorizer 176 retrieves the image from repository 170 and supplies it to a fingerprint generator 174 producing a fingerprint. Optionally, categorizer 176 may consult with database 178 to see if an entry for an image at a location already exists, and if so the system may skip presentation of this image for categorization or may fill in the prior categorization for user review. Categorizer 176 supplies the image location to user interface 180, which fetches the image and renders it for viewing by engine 182 and display 184, optionally with obfuscation. A category specification is made for images through user interface 180, which categorizer 176 relates to fingerprints and creates a corresponding entry in database 178.

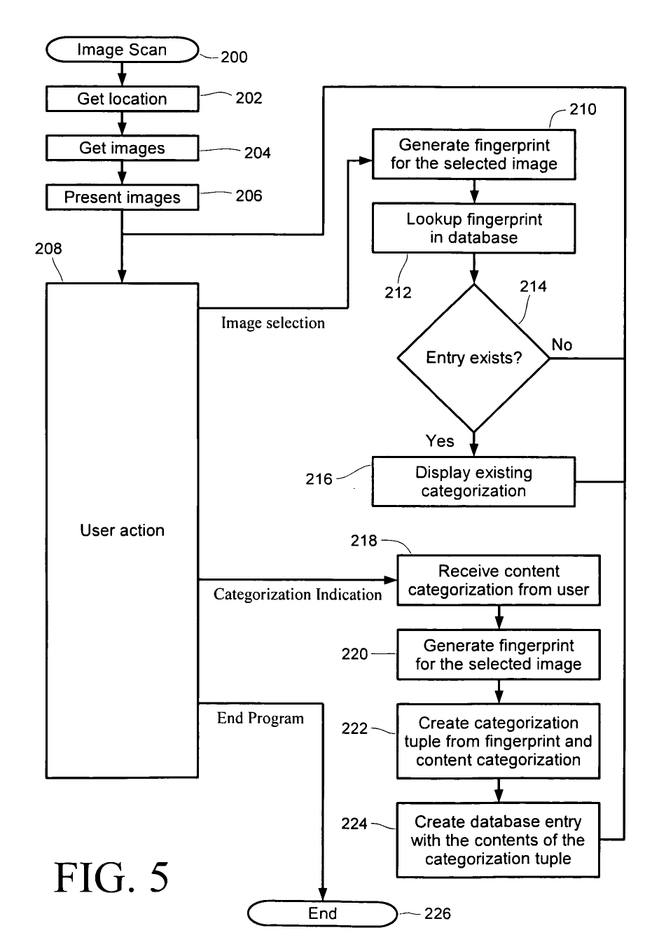

Now presented in FIG. 5 is a representation of a method of scanning and categorizing images. First, it is determined 200 that an image scan will be performed. A location for the scan is received 202, which may be a hard drive, local directory, network directory or Internet location. Having a location, the method proceeds to get the images 204 at that location and presents them 206 for review. Repeated user action 208 is received, the first action being a selection of an image. If an image is selected, a fingerprint is generated for the image data 210 if it does not exist in a cache. Having a fingerprint, the method proceeds to look up the fingerprint in a database of categorizations 212. If an entry exists 214 display is made of the already existing categorization 216. The user may then proceed to take another action 208. In an alternate method, a fingerprint is generated for each image retrieved in step 204 and the display is made of every existing categorization for each retrieved image. This is useful where the primary purpose of the method is to provide an initial categorization of images that location or summary thereof, and the categorization of images of unknown content is a secondary matter.

If through a user action 208 and indication is received the user wants to categorize the selected image, that content categorization is received 218. Next, a fingerprint is generated for the selected image 220 is the fingerprint is presently unavailable. Then a categorization tuple is created 222 using the fingerprint scan the content categorization provided by the user. Having a categorization tuple, a database entry is created 224 with that tuple and the next user action may be taken.

A scanning application may process still images, but may also process video as well. This may be done through sampling of frames in the video at appropriate times, for example through a selection algorithm. A selection algorithm may simply consider individual frames in a defined interval, for example extracting one frame per every five seconds. Other selection algorithms may be more intelligent, examples of which may extract a frame within a fixed time after a scene change, and extract scenes that exceed a threshold of flesh tone detection.

A scanning application is appropriate where corpus of images are available for categorization. In one example, a law enforcement agency may have confiscated the hard drive of a suspected pedophile. A scanning application is appropriate to use first for identifying images on the hard drive that may be ones of a sexual nature and for which a fingerprint is available in a categorization database, and second to apply categorizations to images found on the hard drive to supplement the database. Over time, a law enforcement agency may be able to quickly scan data storage devices and websites, particularly where a characterization database is shared with many other agencies.

Multiple Characterization Submissions

Some of the systems and methods described so far have included a database of image context characterizations that have included a fingerprint in a context characterization. In many situations the submission of a characterization to a database may be authoritative, i.e. it may be presumed to be accurate. This may be true in situations where there is a single submitter, or where there are several submitters operating from a fixed and well-defined specification. However, there may be other situations where submitters are not known or do not operate from the same standard.

A characterization database may be configured to store a plurality of characterizations for the same contextual item in combination with some other information for selecting between the characterizations. For example, it may be that an image characterization database is available to the general public for the submission of characterizations for the subjects of sexually explicit content, violent content and child-inappropriate content. There may be many images that could fall in or out of those categorizations depending on the subjective opinion of the submitter.

In a first exemplary scheme, each categorization in the database is accompanied by an identity for the submitter. The identity may specify or indicate a level of trust or categorizations submitted by the person of that identity. For example, the operator of the database may know that a particular individual produces categorizations that are widely agreed to be correct; such an individual could receive a high degree of trust. Alternatively, it may be that incorrect categorizations are regularly submitted through another identity. That identity may receive a low degree of trust. The trust levels may be stored with categorizations, but it may be more effective to store the identity of a submitter with the categorization and then perform a separate lookup to determine the trust level for that identity. By doing so changing the trust level for an identity is a simple operation, should that become necessary. In another exemplary scheme, a temporary entry may be made in the database for user submissions from users that are not completely trusted. When a second or subsequent categorization is made against a fingerprint with a sufficient cumulative level of trust and with the same or a similar categorization, the entry may be made permanent.

The server of the database might return to a requester all categorizations of a fingerprint, or a selected number of categorizations based on a criteria such as categorizations with the highest levels of trust. Alternatively, the server of a database and effectively pick which categorization to use by returning only one categorization, for example the categorization with the highest level of trust or the one most popular.

In another exemplary scheme, identities are not tracked but rather a system serving the database operates from an algorithm that selects one categorization from several that may be available. An algorithm might select the most common categorization, selecting the most negative between two or more that are the same in popularity. An algorithm might also select the most negative categorization where a minimum number of submitters agree to a negative characterization. For some categorizations, i.e. those where it is better to err on the side of caution such as sexual or violent content could be viewed by a child, the most protective categorization may be returned, optionally considering a minimum level of trust. Other schemes and algorithms may be applied and desired.

Exemplary Scanner

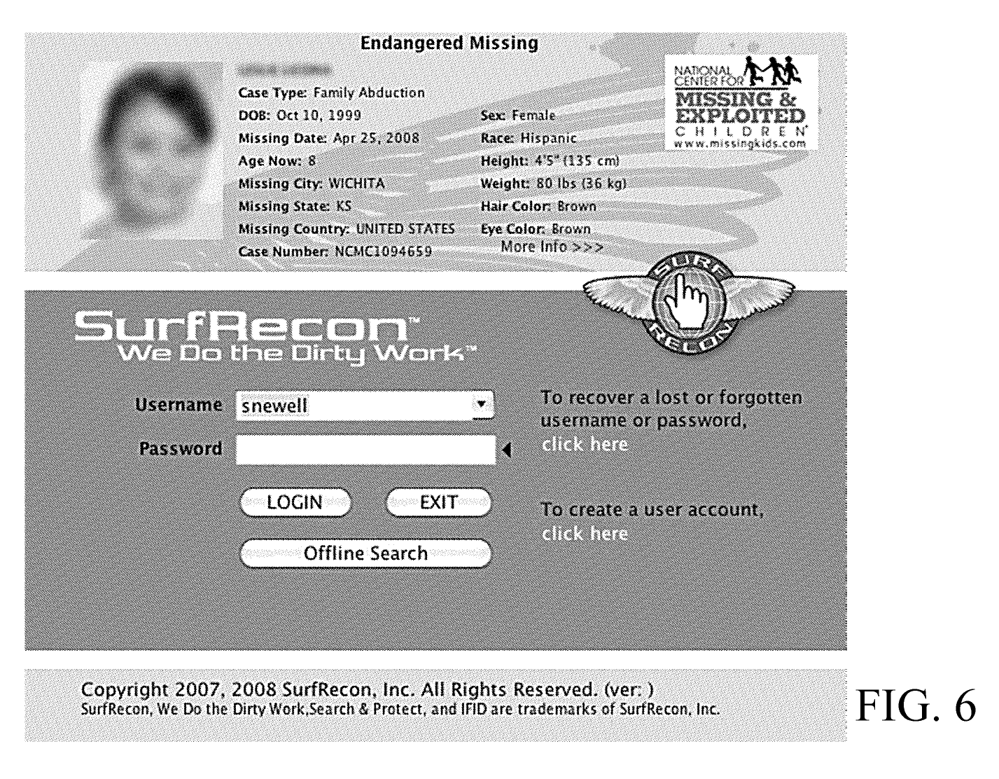

Many of the concepts presented herein are more easily understood with reference to FIGS. 6A through 6K representing a series of screens in an exemplary scanner program. Beginning with FIG. 6A, the exemplary scanner first begins with a login page wherein a user may identify or authenticate himself to the program. Upon logging in, the user may see a screen as in FIG. 6B containing the main areas of program, which are a source specification area 400, an image view area 402, an image information area 404 and a thumbnail view area 406. The source specification area 400 contains three “quick search” buttons for selecting a source for scanning, being the common specifications of a browser cache, a user home directory and all storage on the computer (respectively “browsers”, “home directory” and “all drives”). A custom search specification is also provided, wherein a user may specify a particular directory on the computer to scan. For the purposes of this discussion, a user selects the “browsers” button, indicating that the user wishes to scan the browser cache.

Continuing to FIG. 6C, the program state enters a scanning state, here in the browser cache, which state is indicated in the source specification area 400. As images are found thumbnail view area 406 is populated with thumbnails of the images found; thumbnail view area 406 including navigation controls such as scrollbars or page navigation buttons. A summary 408 is provided to show the state of the scanning operation, displaying the number of files found, images found, images analyzed, image content categorizations query to a database, elapsed time, and an image currently being analyzed. Turning to FIG. 6D, one of the images found may be selected in thumbnail view area 406, causing image view area to display the image and also causing image information area 404 to display information related to the image, here that information being the file name of the image and the location from where it was downloaded.

Further describing image view area 402, this area is designed to permit a user of the scanning software to view the images in several levels of detail without unnecessarily exposing himself to undesirable content. Within view area 402 are controls 410 for zooming, repositioning the view of the currently selected image and for exposing apetured portions of the image, described presently. Obfuscation selection controls 412 select the level of obfuscation applied to the currently selected image. In the view area 402 of the exemplary software, the obfuscation method is a blurring of the image. By default the exemplary software blurs the image display thus avoiding exposure to the potentially damaging details within the image. In the course of categorizing an image, it may be that a user needs to see more detail, upon which the user may select less obfuscation or here blurring. Obfuscation controls are also provided for thumbnail view area 406, by which the collection of display thumbnails may be obfuscated and again here blurred.

Now continuing to FIG. 6E, a user may expand one of areas 400, 402, 404 or 406. Here, the user has expanded the image view window for ease of viewing. Also in this Figure, the user has used an aperture tool to expose portions of the image while leaving the remainder obfuscated. The aperture tool, or keyhole, works much like a paint brush, the size of the brush being controlled by slider 414. The user may move the cursor over an area of the image and click to apply the aperture tool. The program exposes the image under the aperture tool, thus allowing the user to clearly see portions of the image without having to view the image in its totality. Note that an aperture need not be circular, but can be square, ovoid, etc. Aperture tools may be used in other applications and contents, particularly where the user is to be protected from the full exposure of potentially harmful image. This may be particularly important where a person is to examine many images that contain potentially disturbing content. If the user applies the aperture tool in an undesirable way, the list of key holes can be wiped clean and the user may start again.

As seen in FIG. 6F, thumbnail view area includes a categorization summary 418 listing the number of images found in the scan according to category. In this example, the categories are safe, sexual, child porn and personal. If, during the scan, and images found that has not been categorized it is considered to be “unknown”. A submissions area 416 may be opened by the user showing a summary of categorization submissions by the user for the session.

The exemplary program produces fingerprints from two different hash values according to the MD5 and SHA-1 hash algorithms. The combination of these algorithms produces a fingerprint by which categorizations are indexed in the database. In FIG. 6F, image view 404 displays these hash values along with other information of the currently selected image.

The exemplary scanner provides additional functionality for prosecutors and/or law enforcement personnel, allowing for annotation. Now referring to FIG. 6G, a user may display a list of key holes in case notes for annotation. Now turning to FIG. 6H, the user has selected an image and has selected to enter case information for that image. This case information entry form 420 is suitable mainly for child pornography, and has an entry for a case number, the number of persons represented in the image and their genders, ages and race, and a further entry for miscellaneous notes. Key holes may also be annotated with a description, as seen in FIG. 6I.

The exemplary scanner also allows for the generation of reports. As seen in FIG. 6J, a report may be initiated through a form whereby the report name, date, suspect's name and address, computer location and other miscellaneous notes can be entered. Upon selection of the create button, a report is generated in the scanner programs internal format. Now turning to FIG. 6K, a manager reports view is provided listing the reports that have been created by the program. Options are provided for viewing report, deleting a report and creating a PDF copy of the report for printing and distribution.

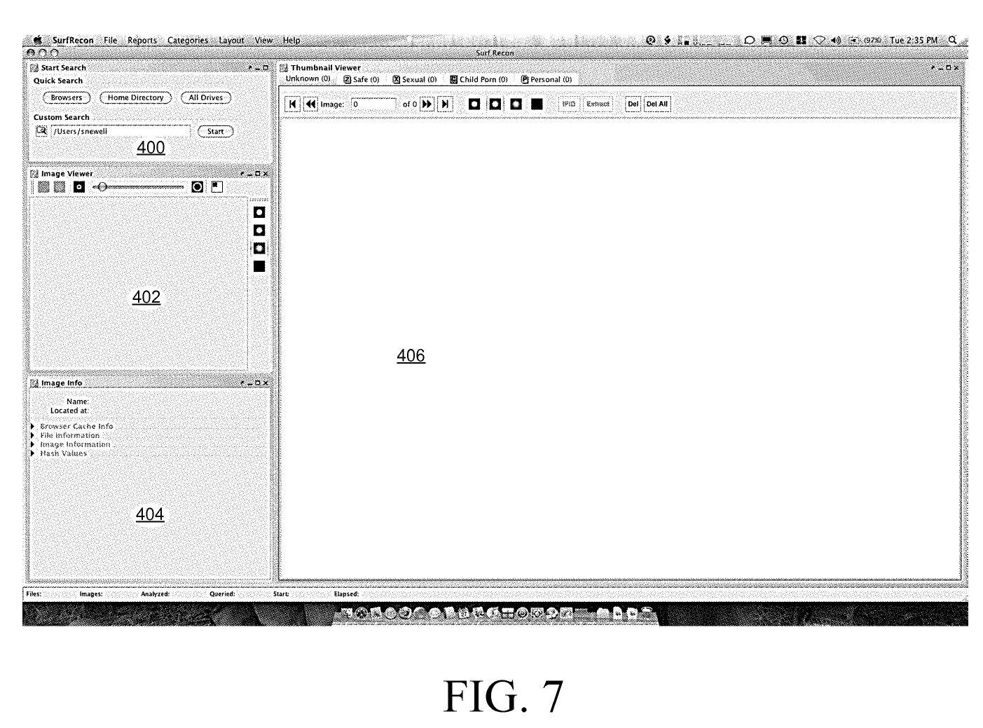

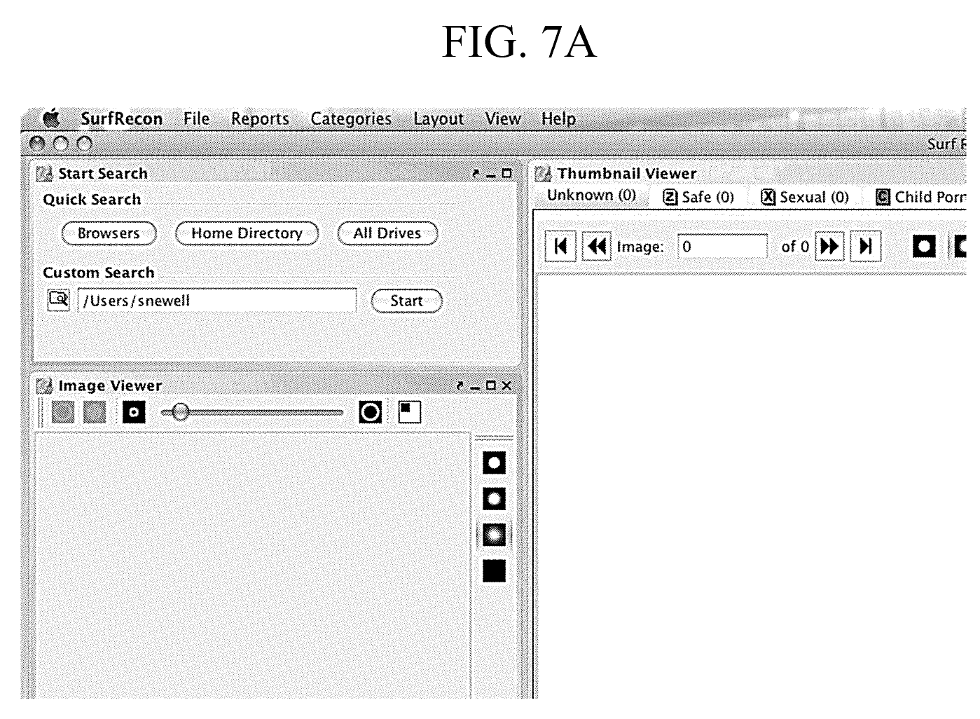

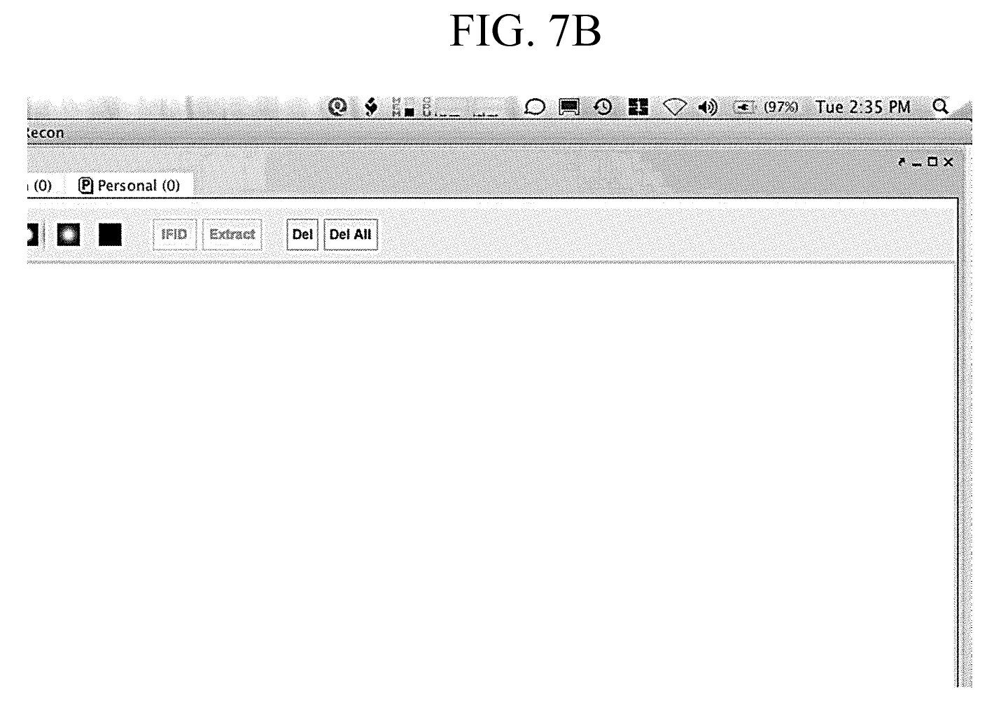

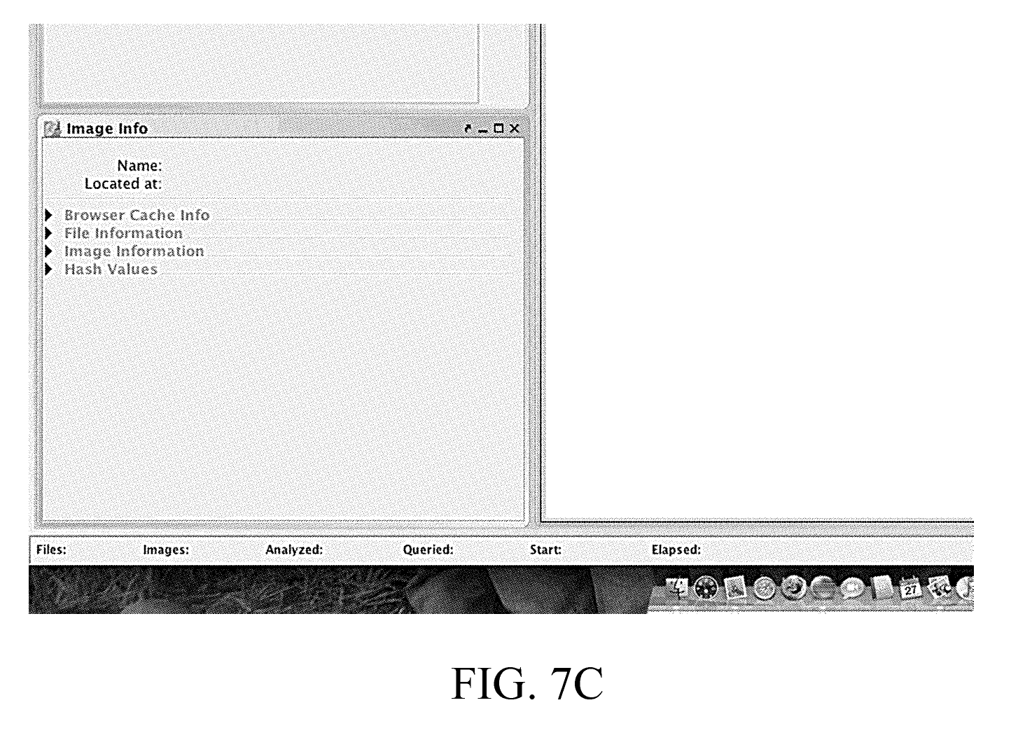

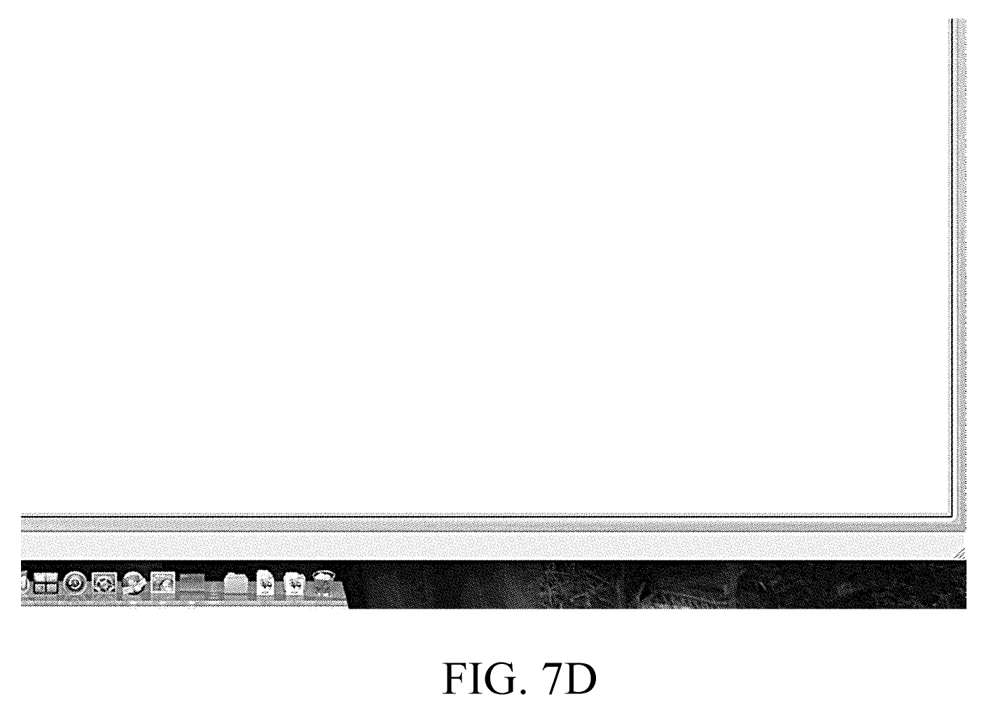

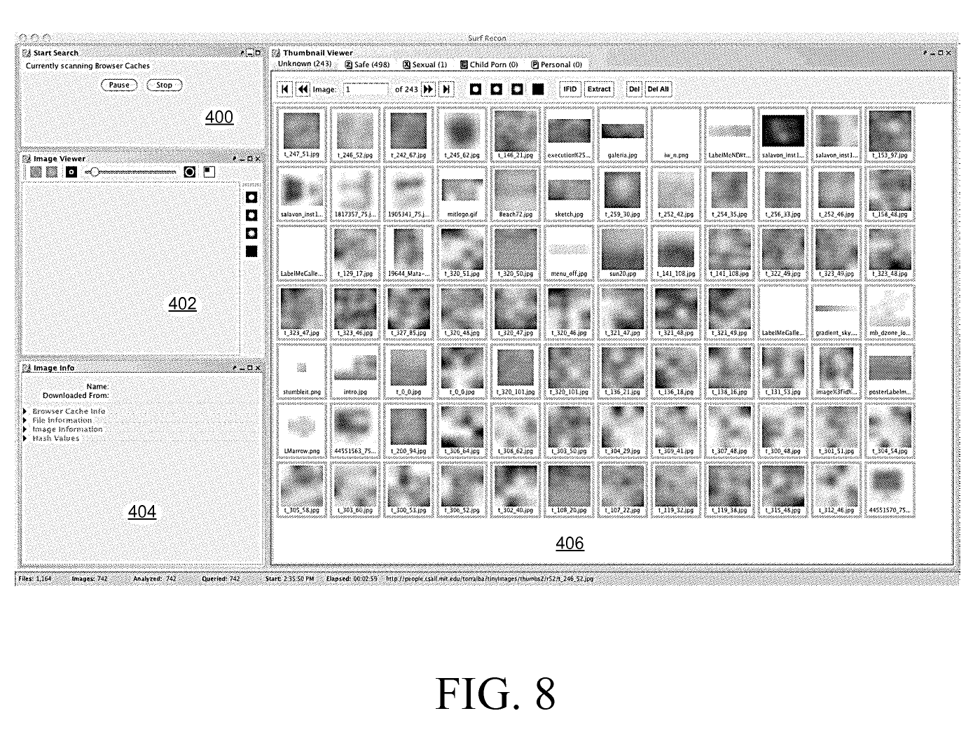

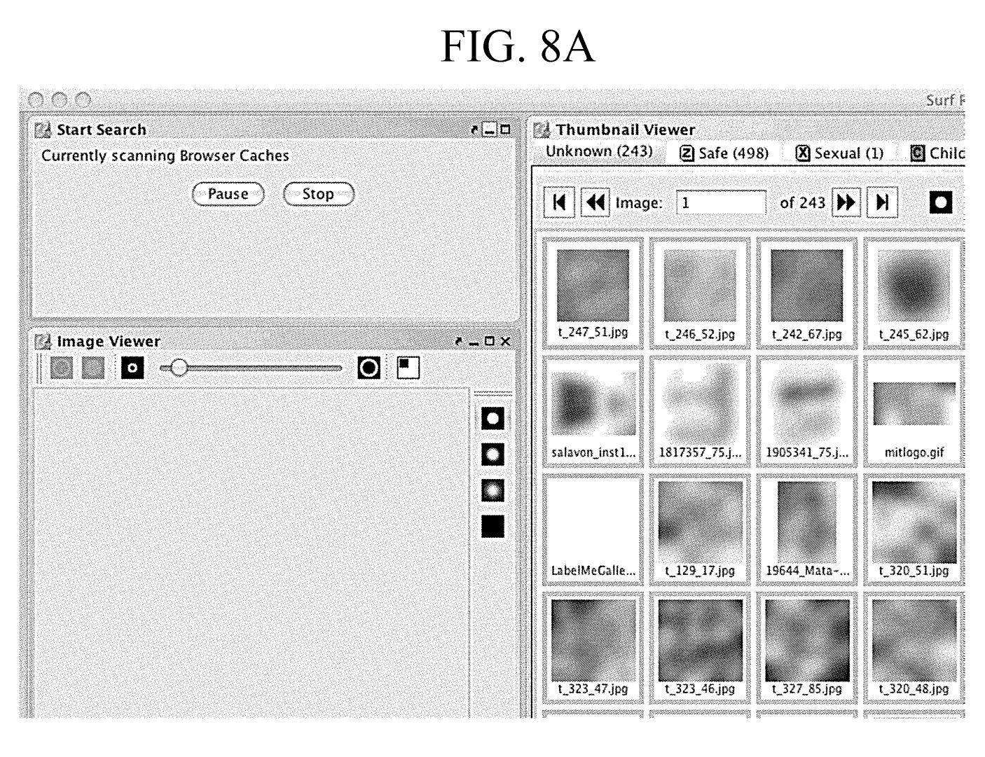

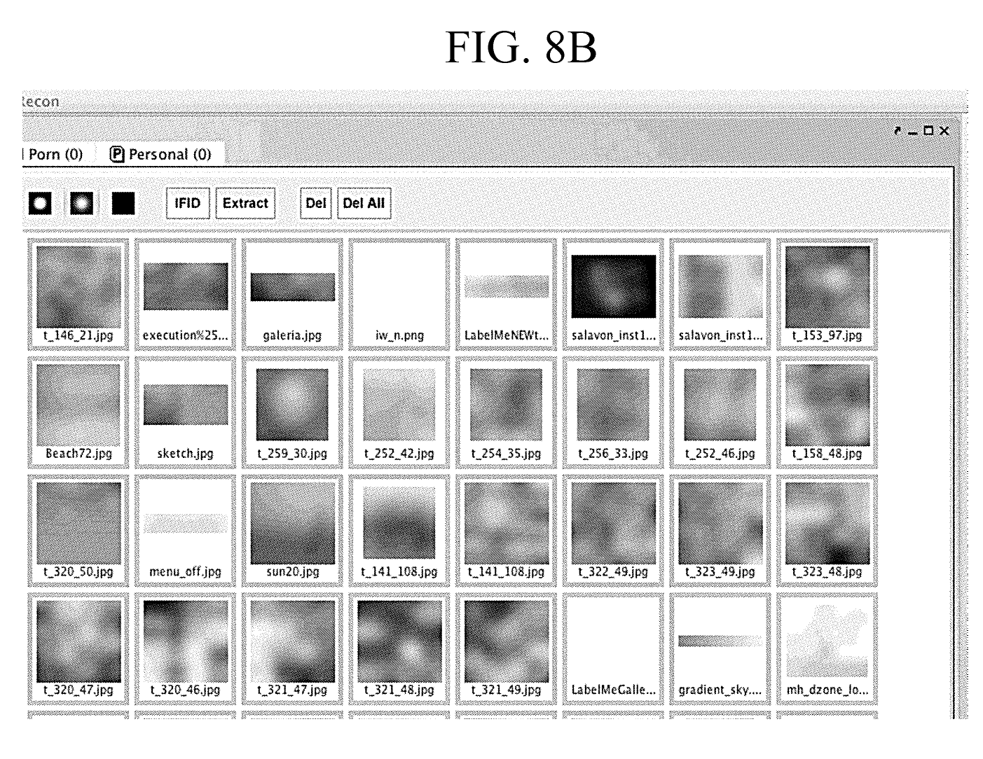

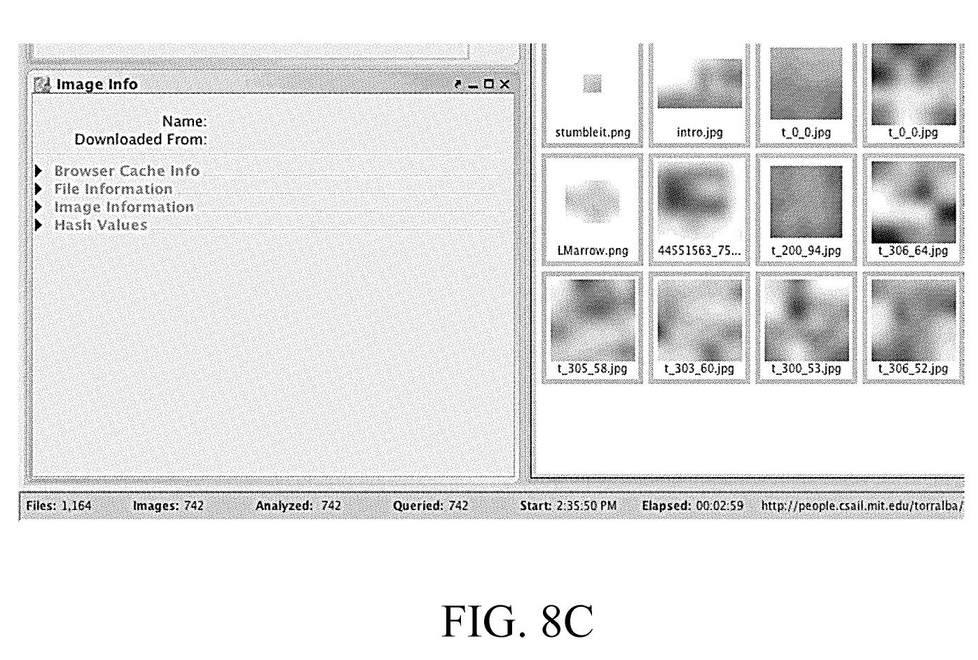

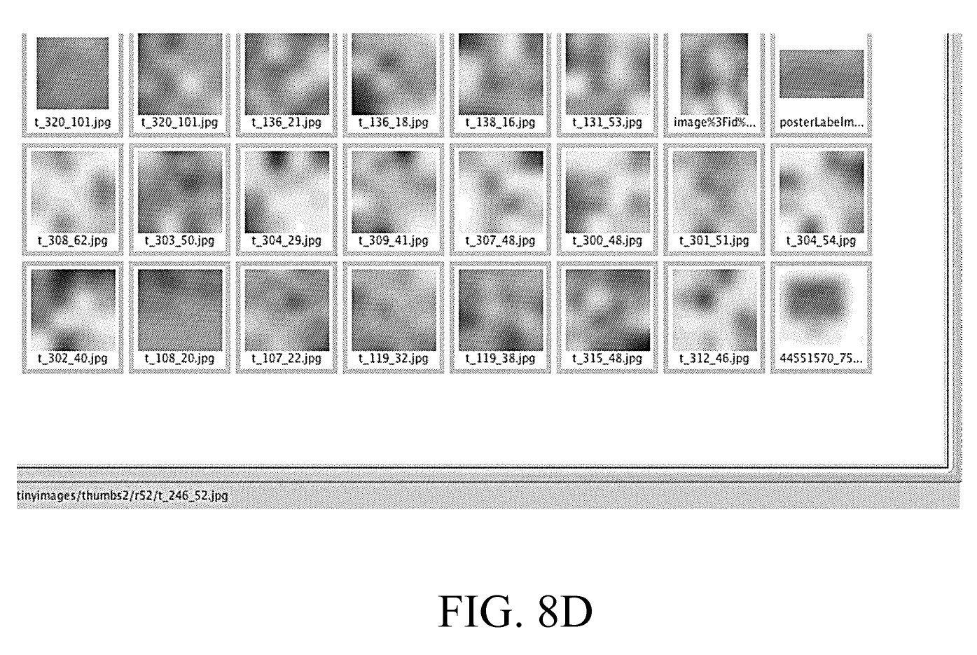

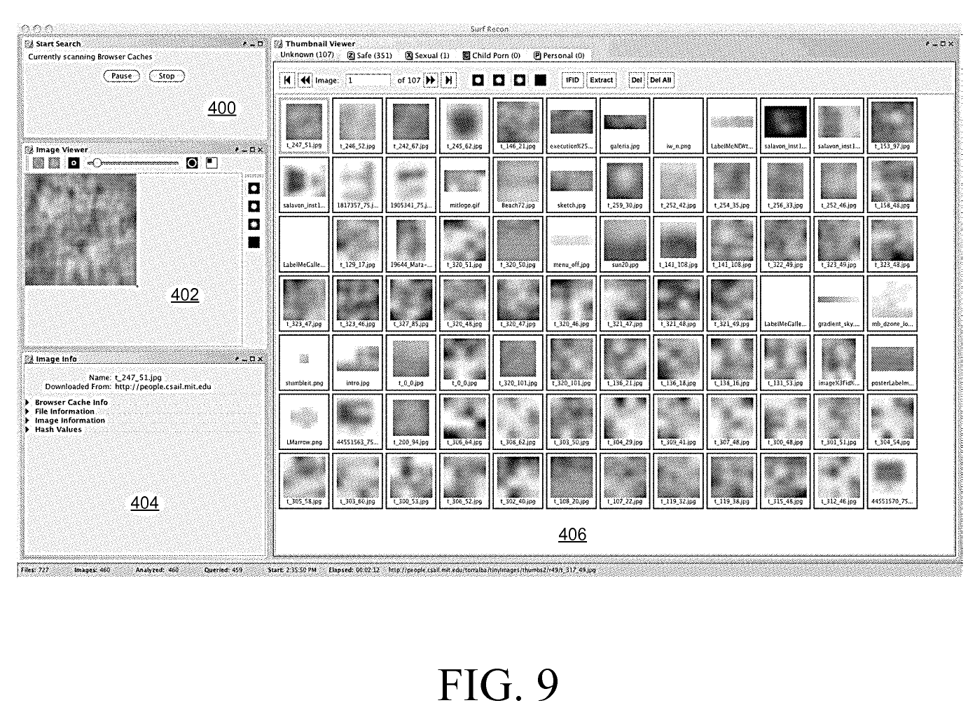

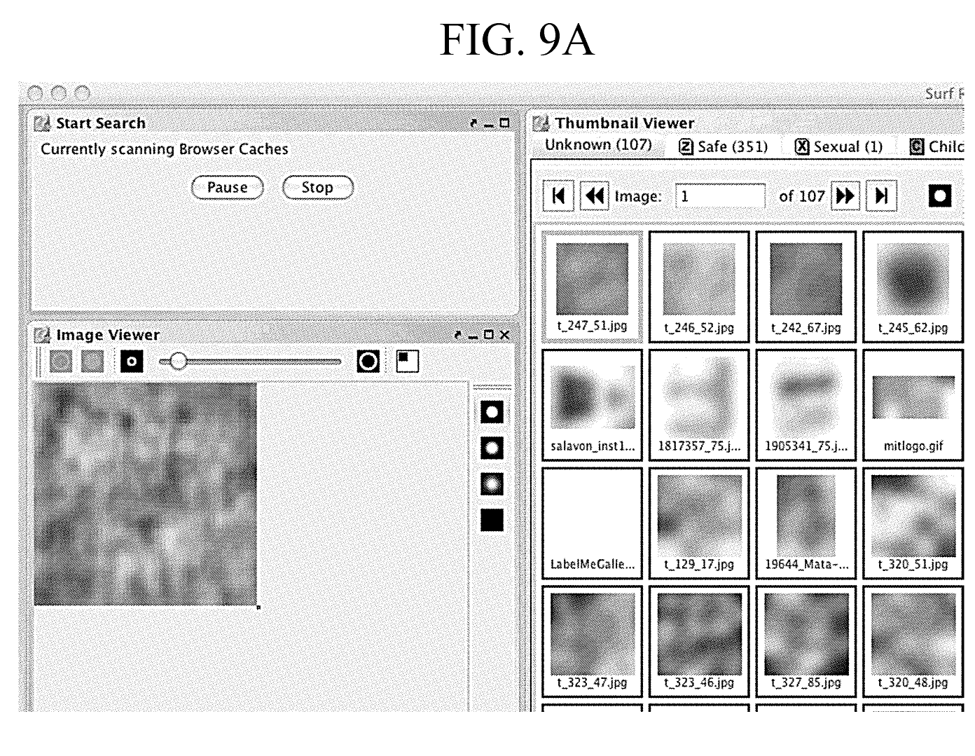

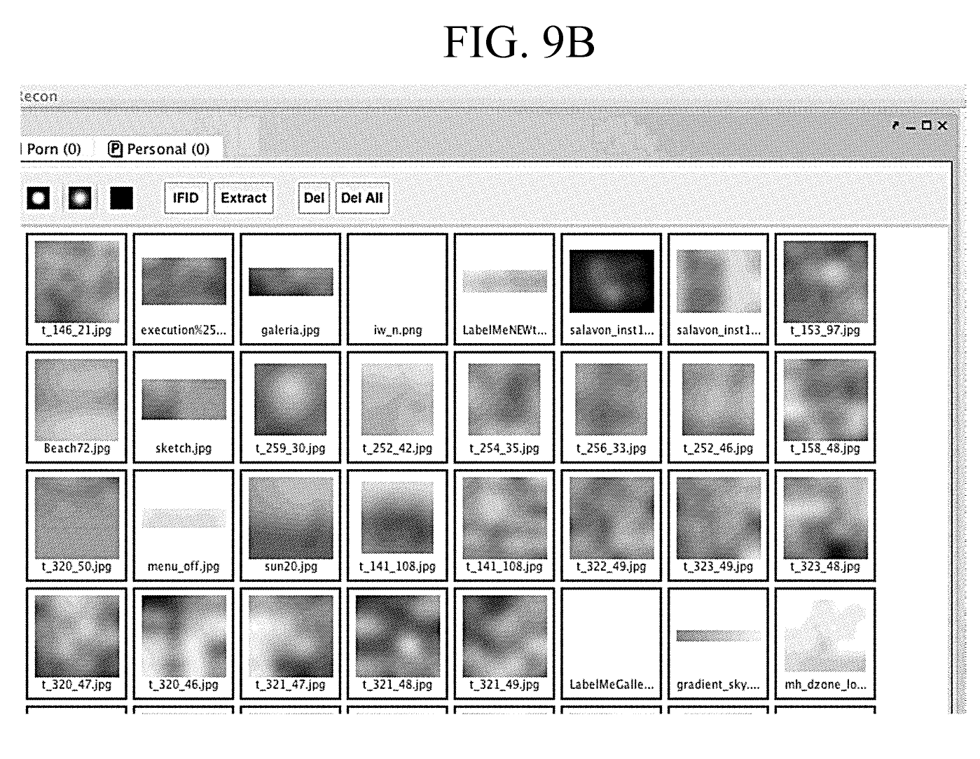

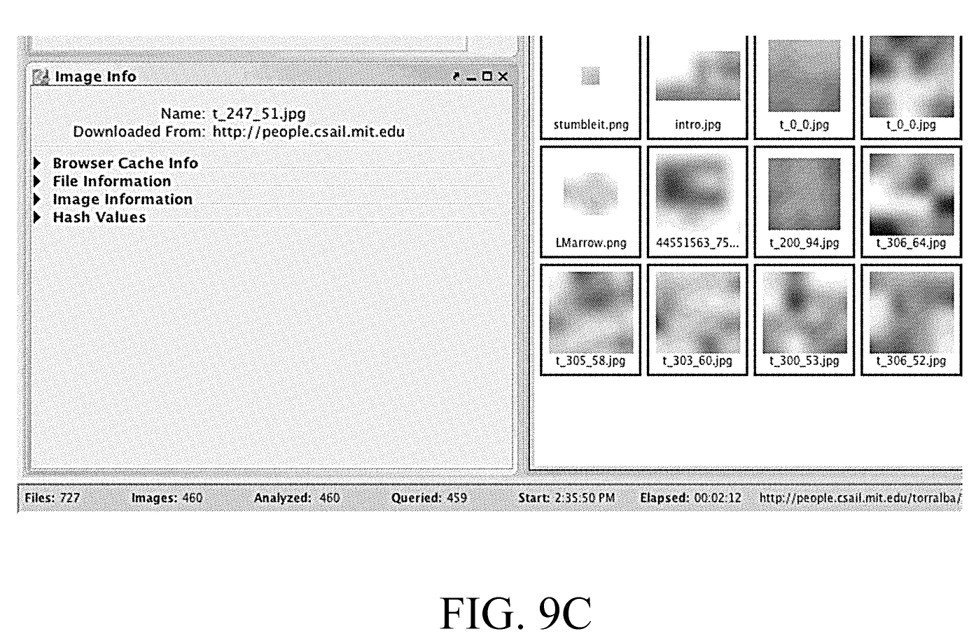

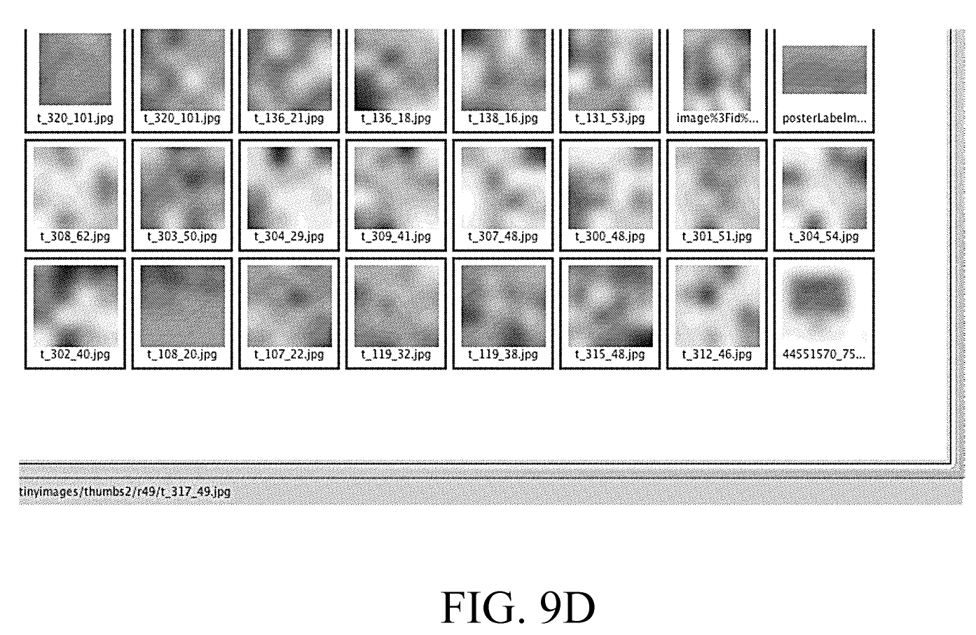

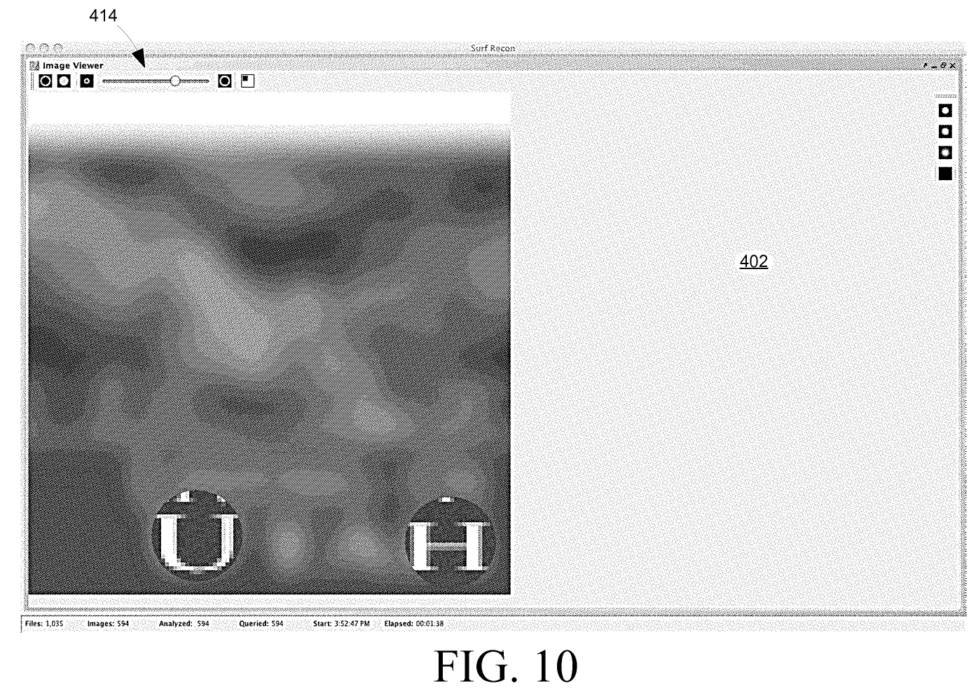

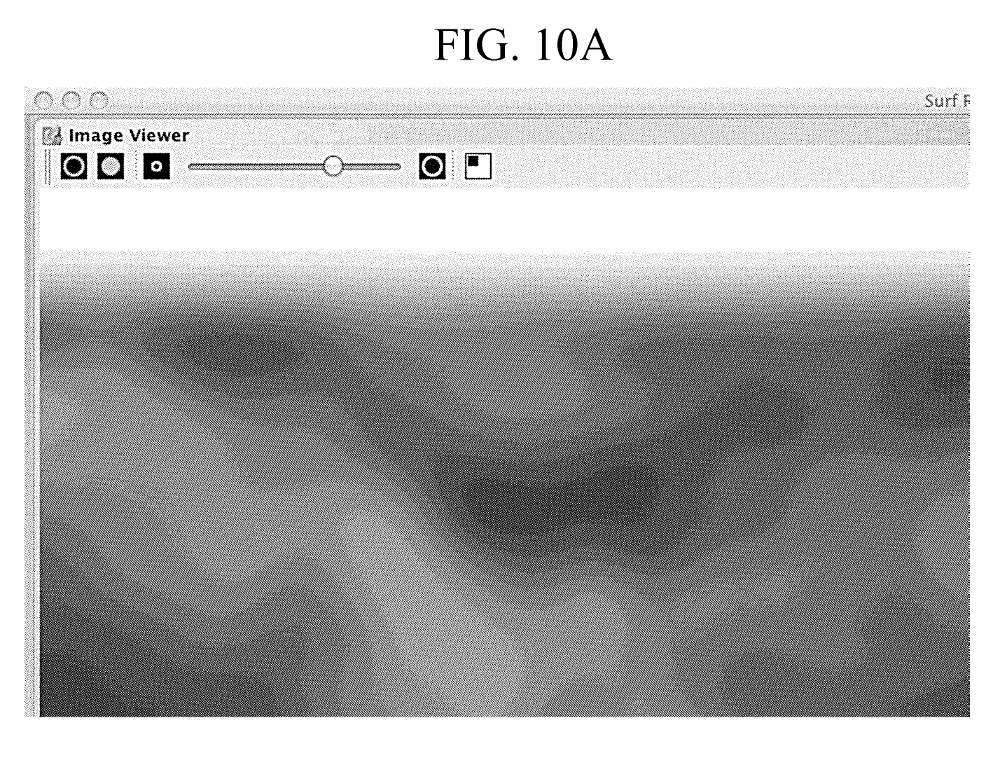

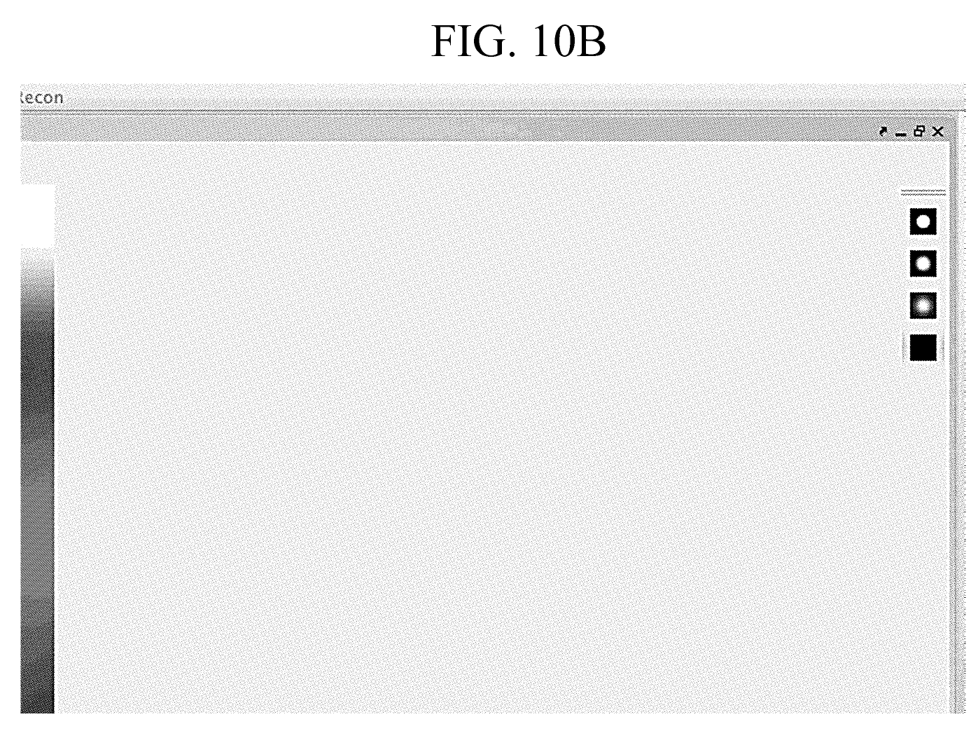

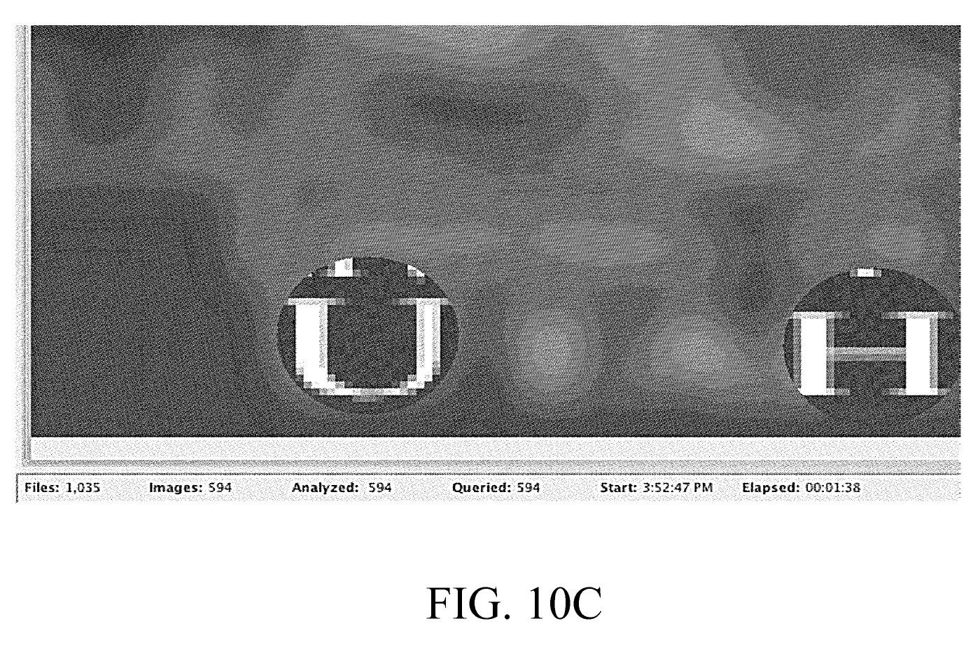

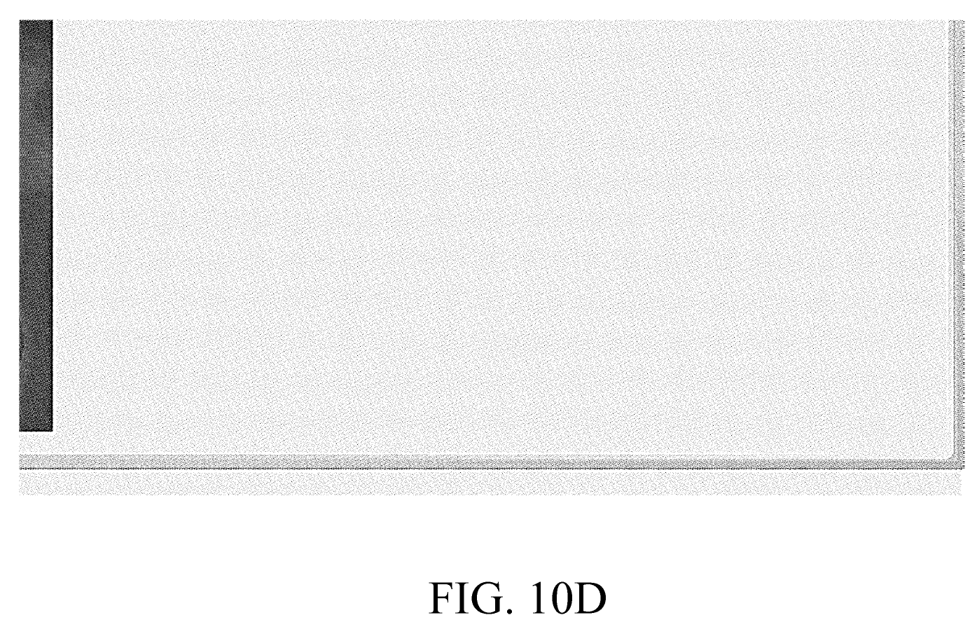

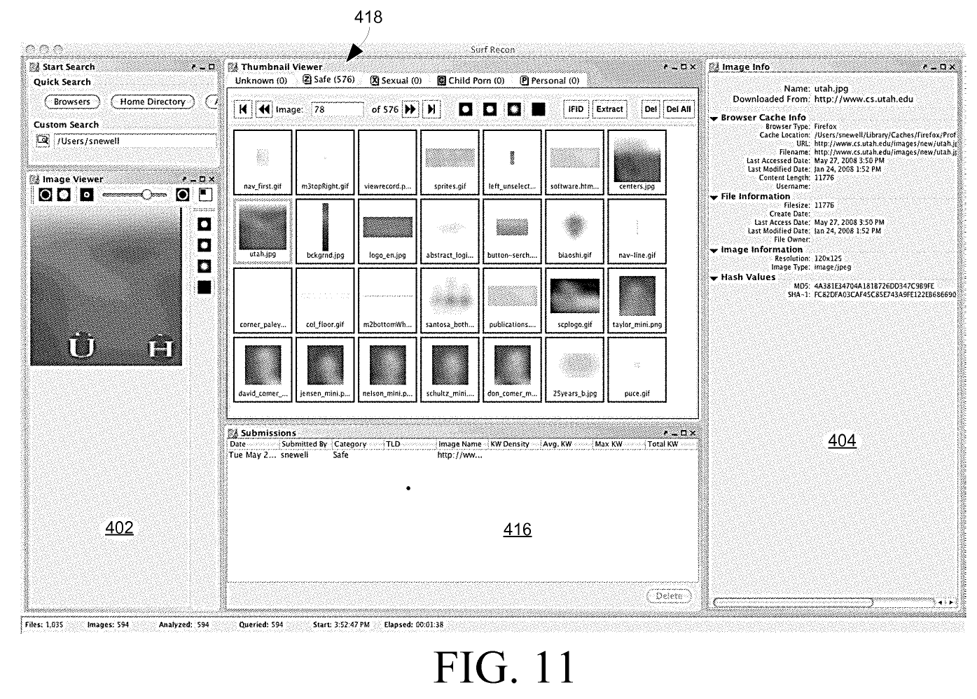

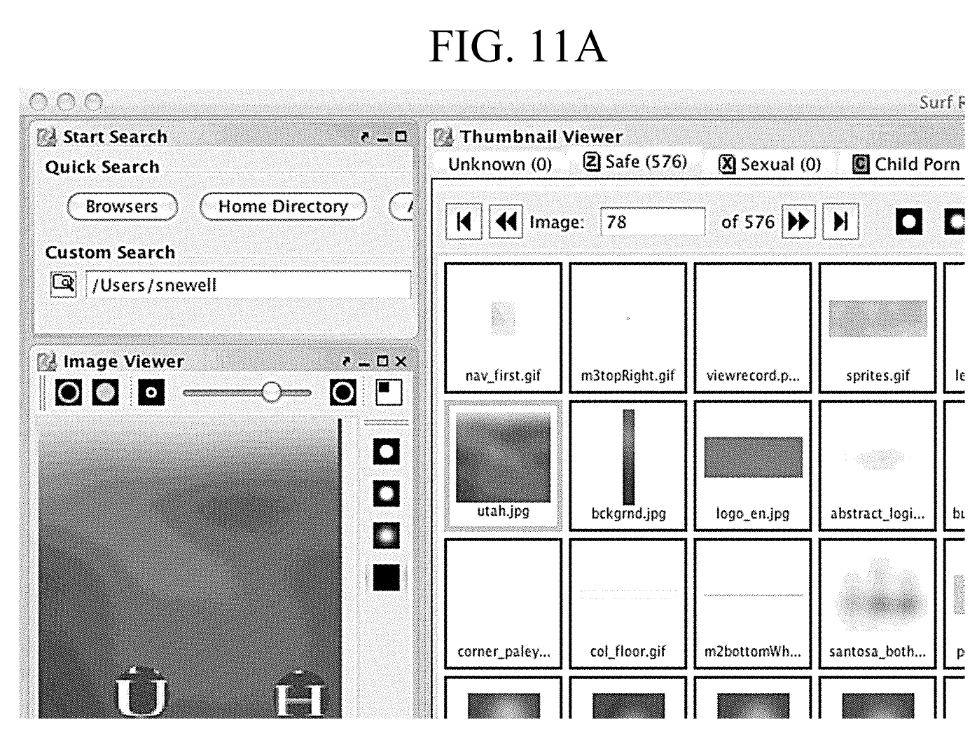

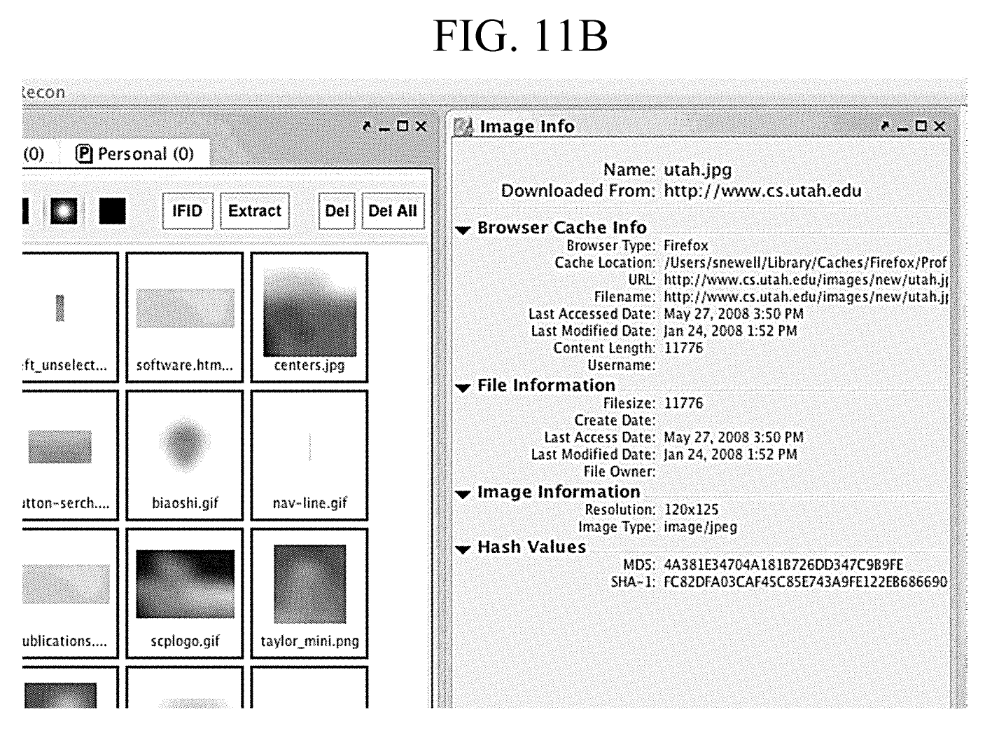

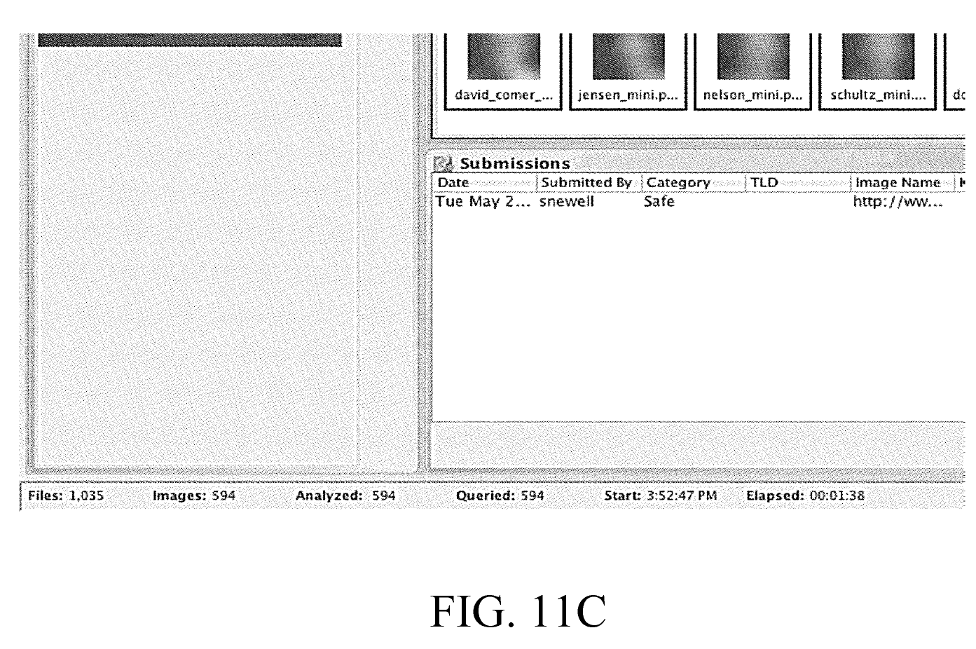

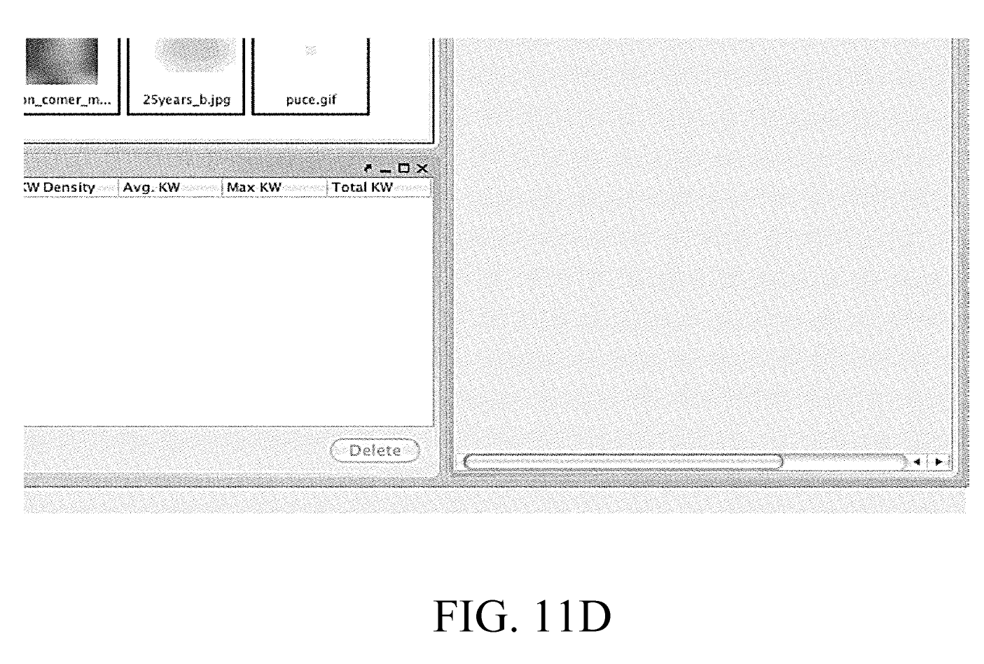

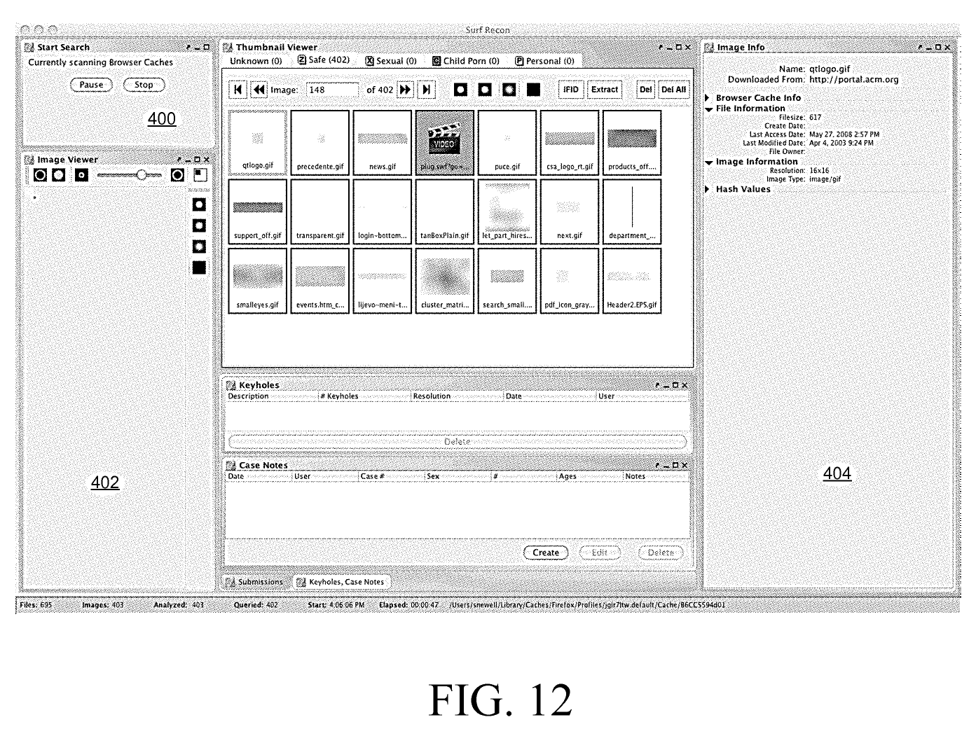

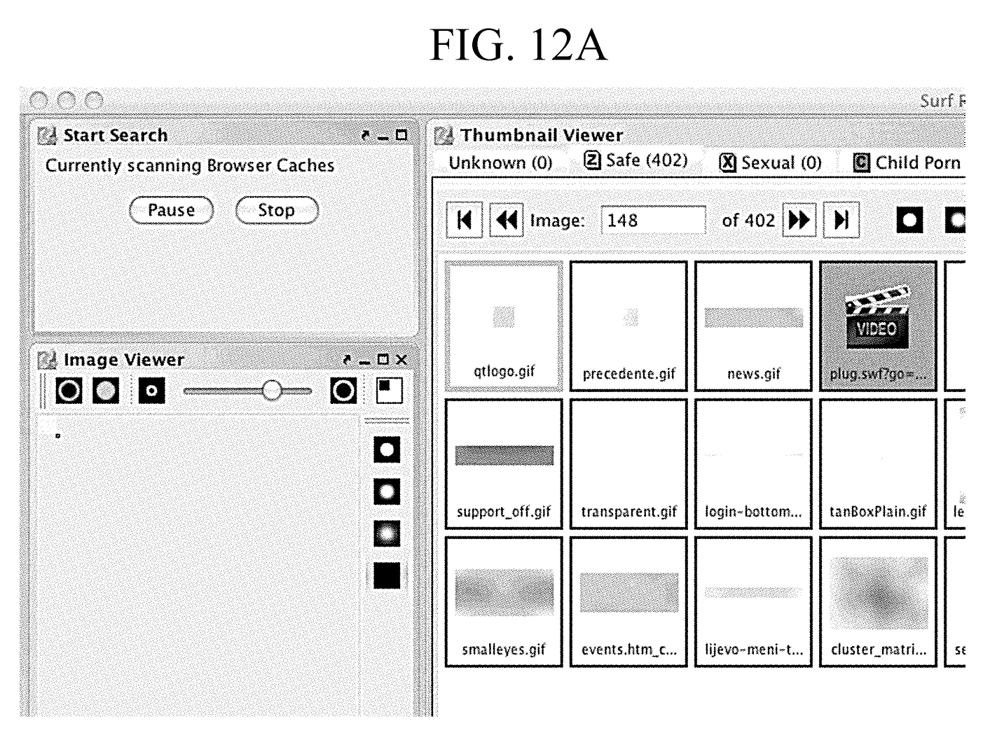

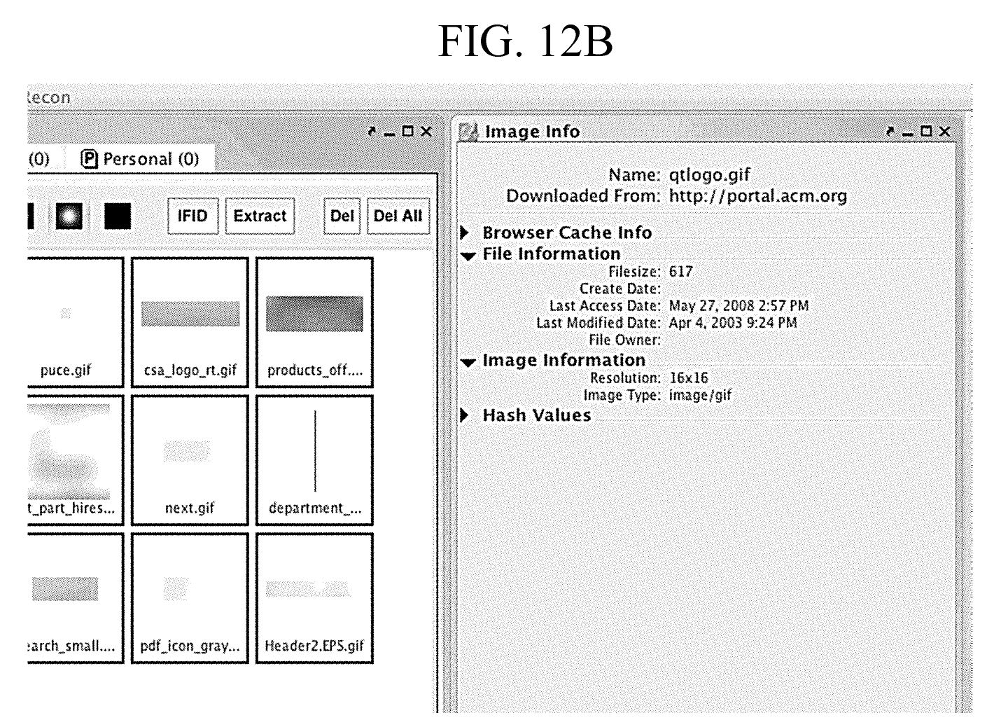

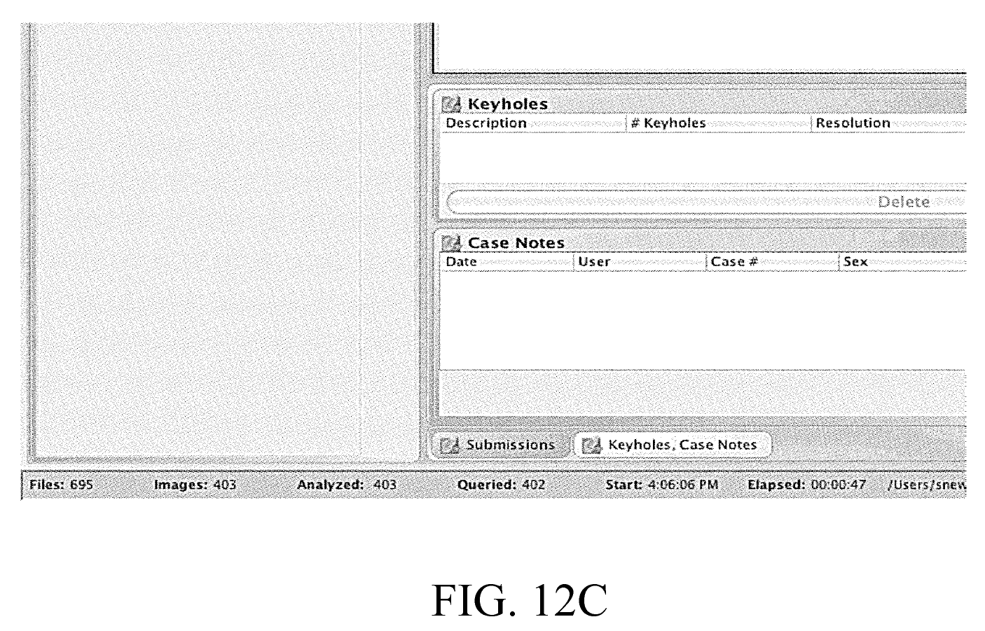

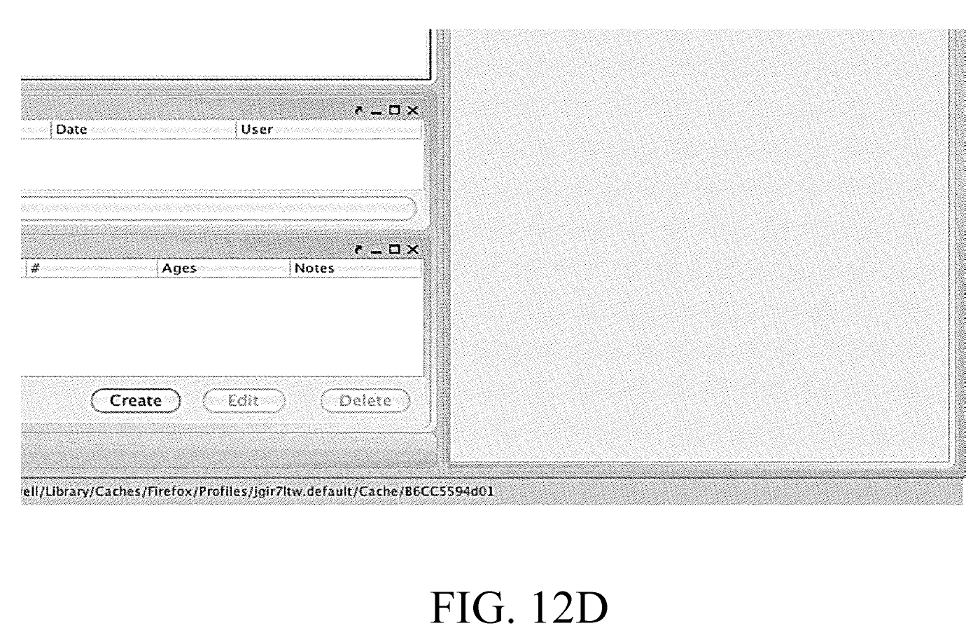

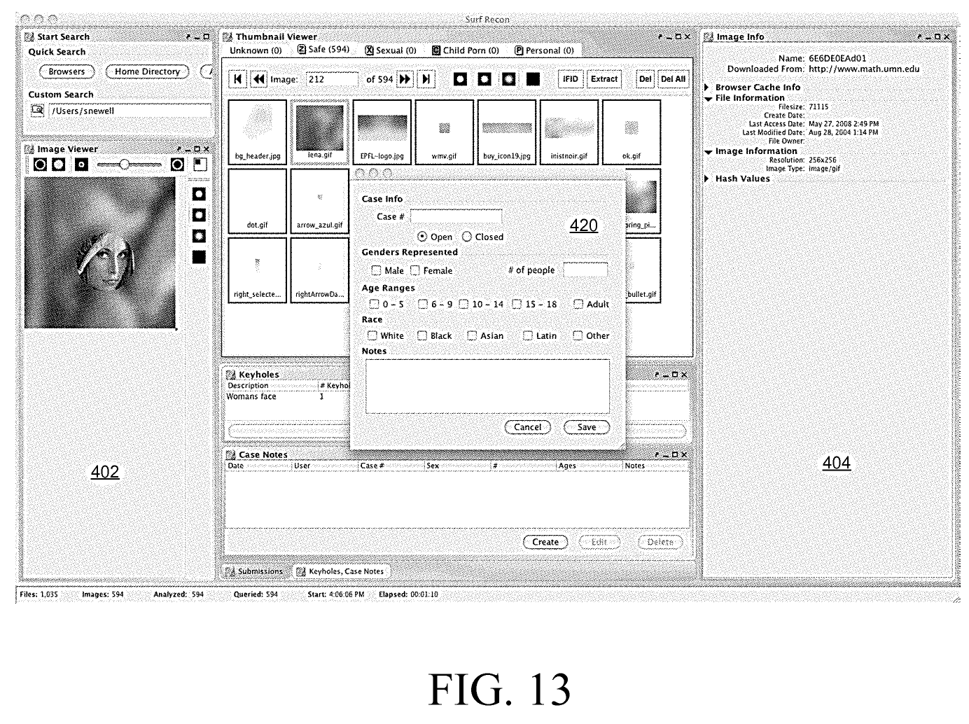

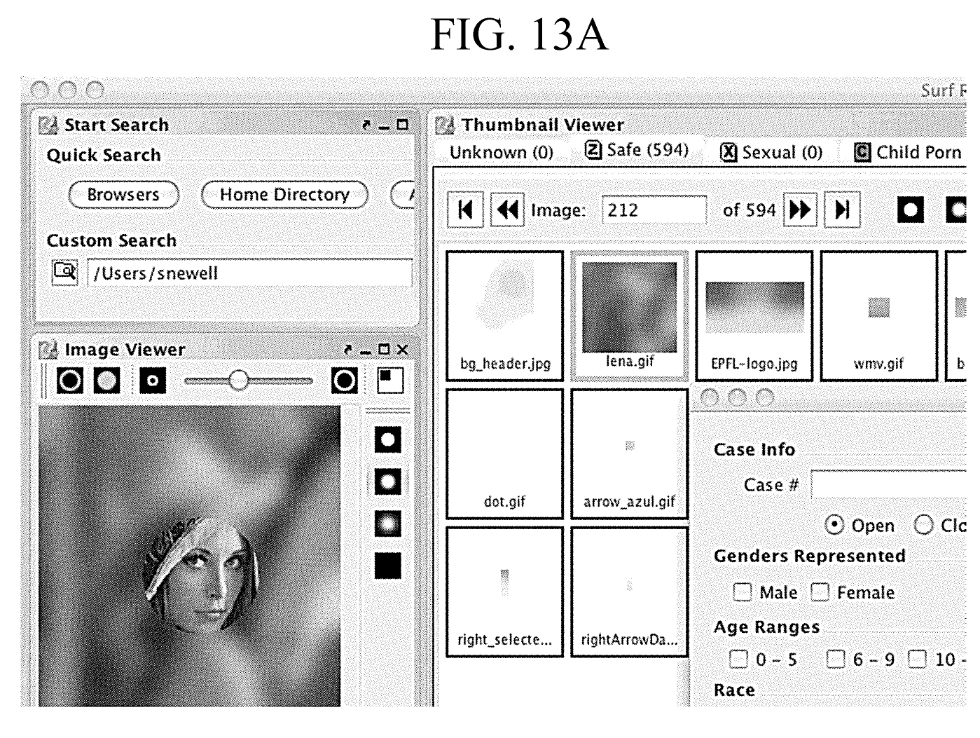

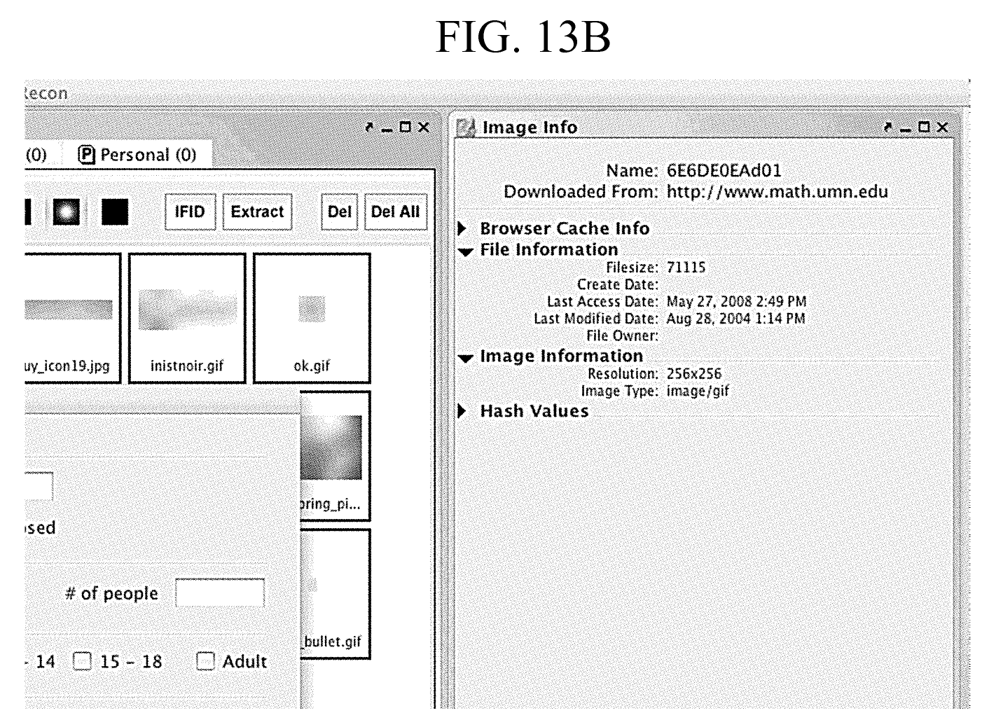

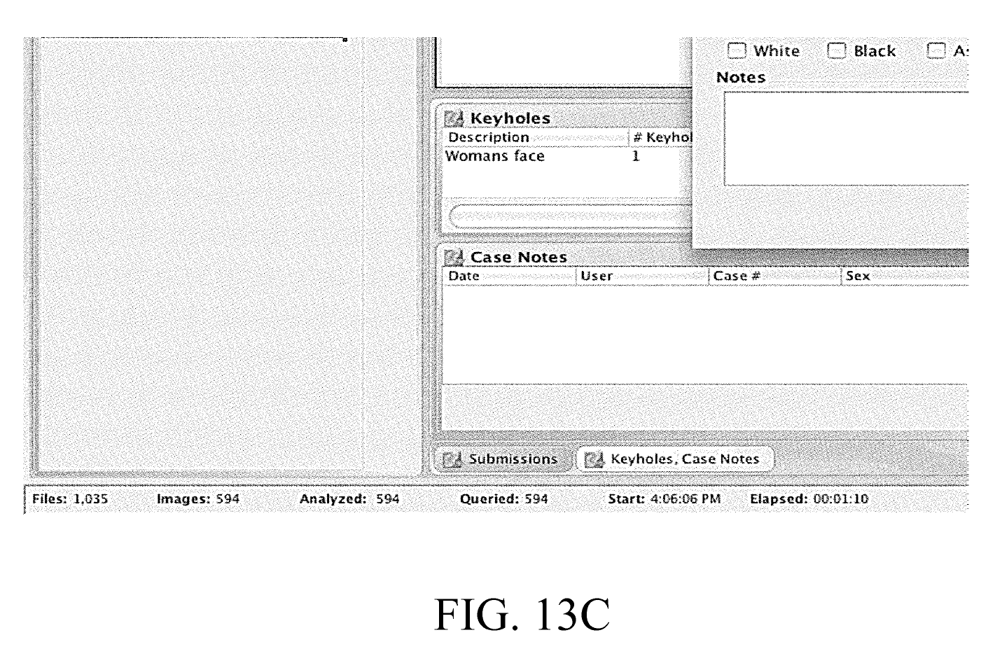

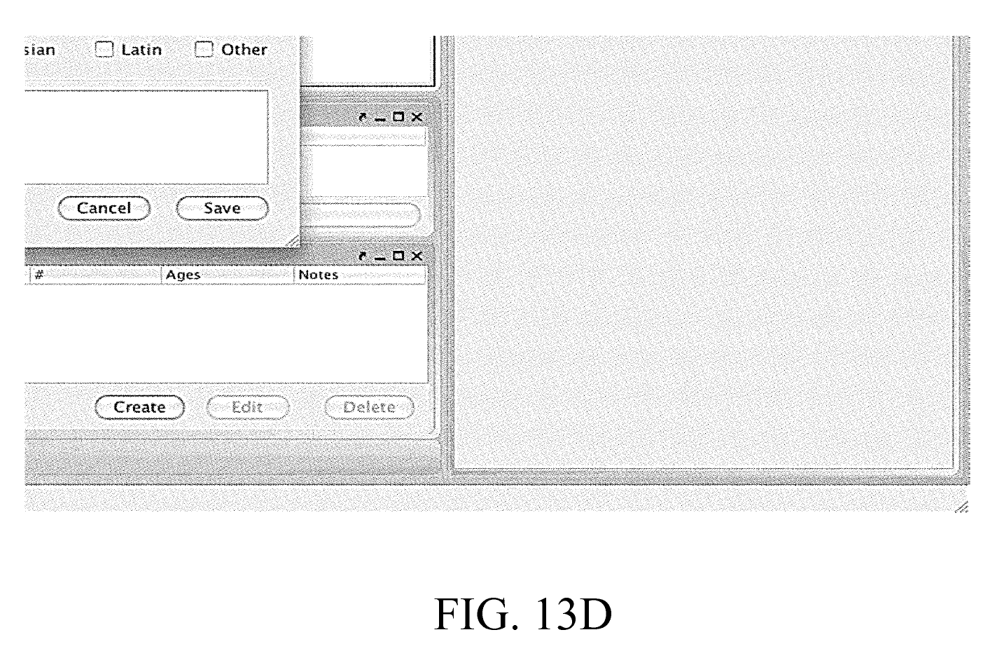

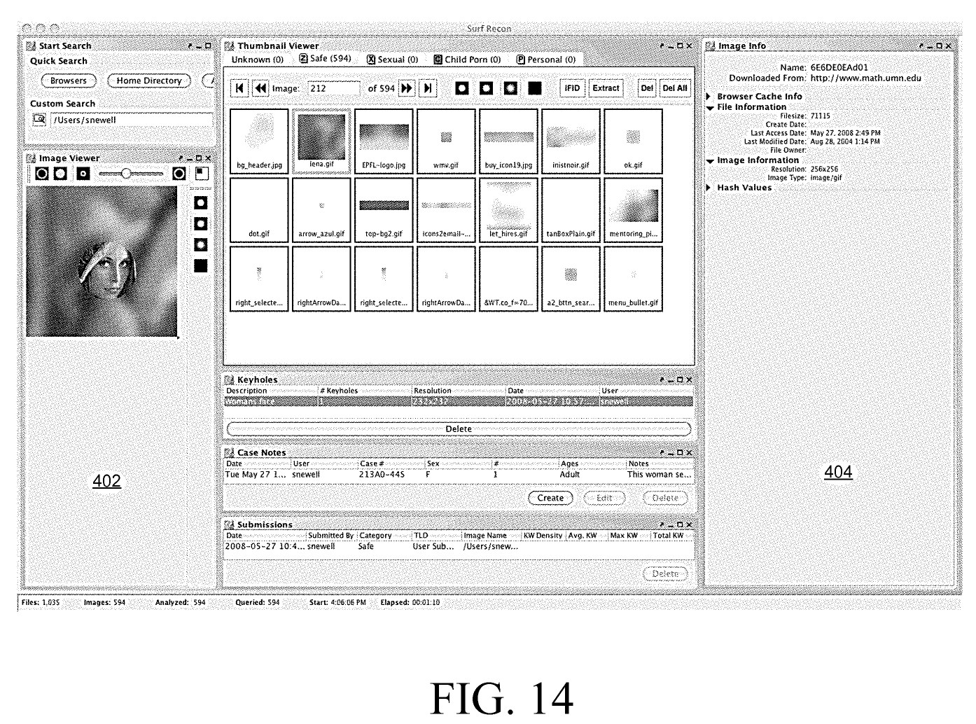

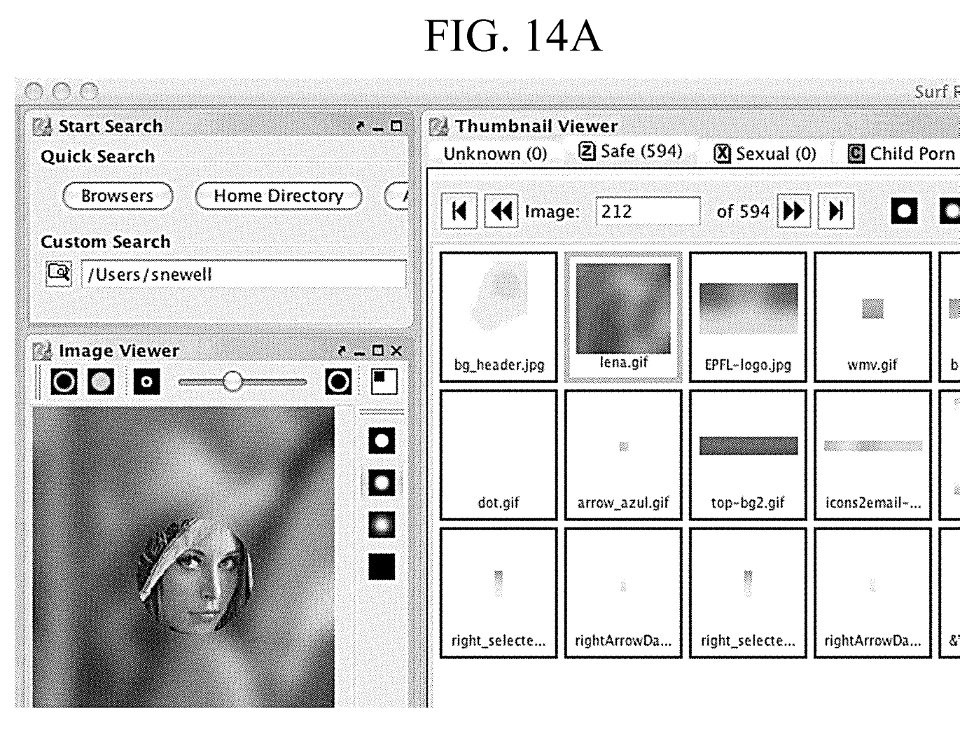

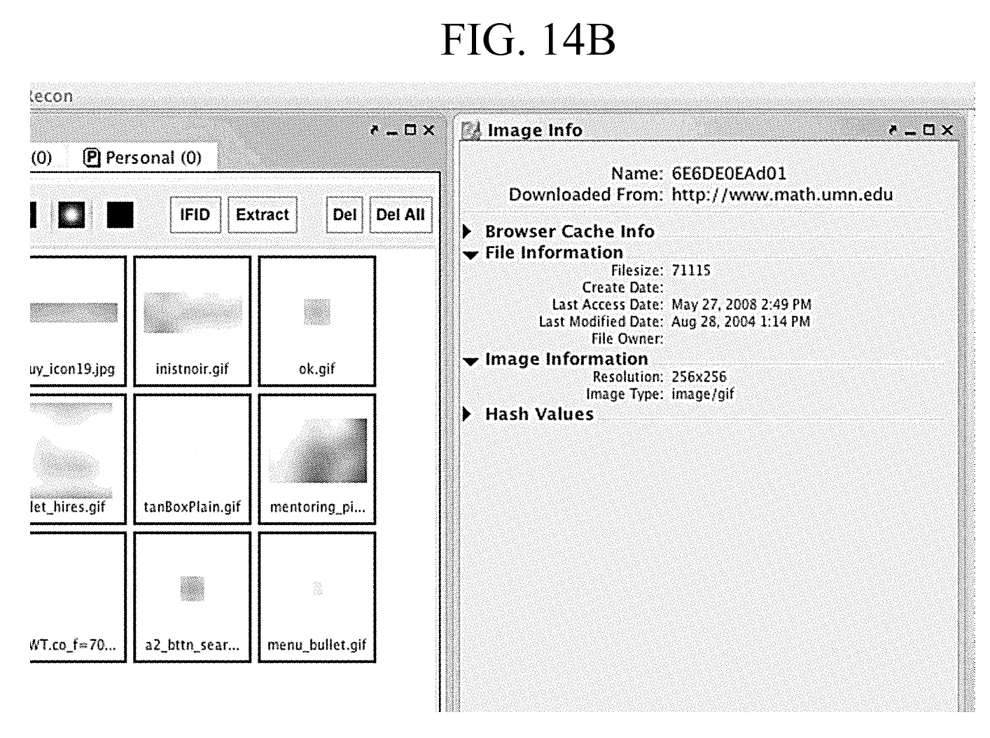

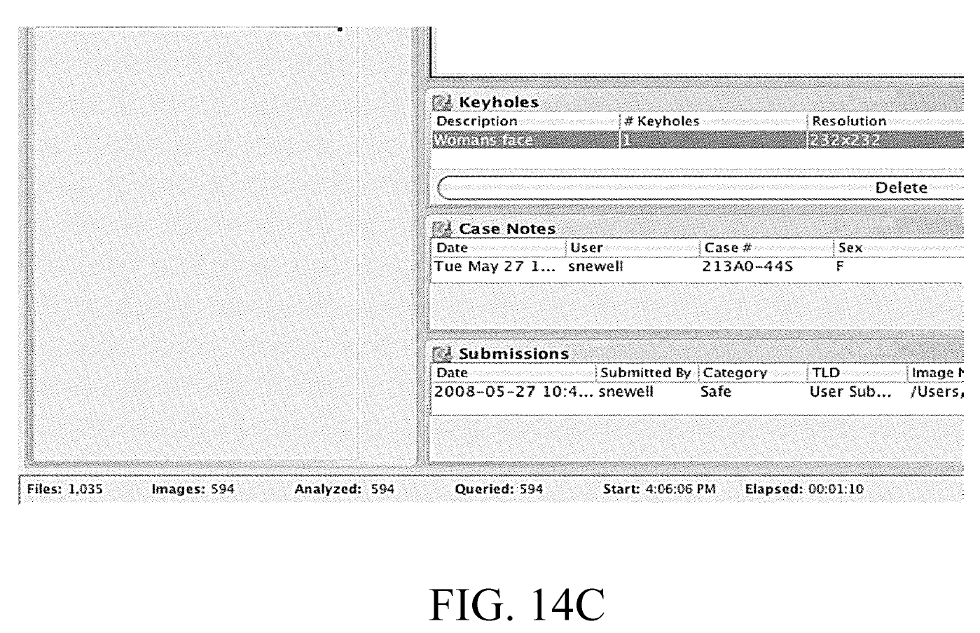

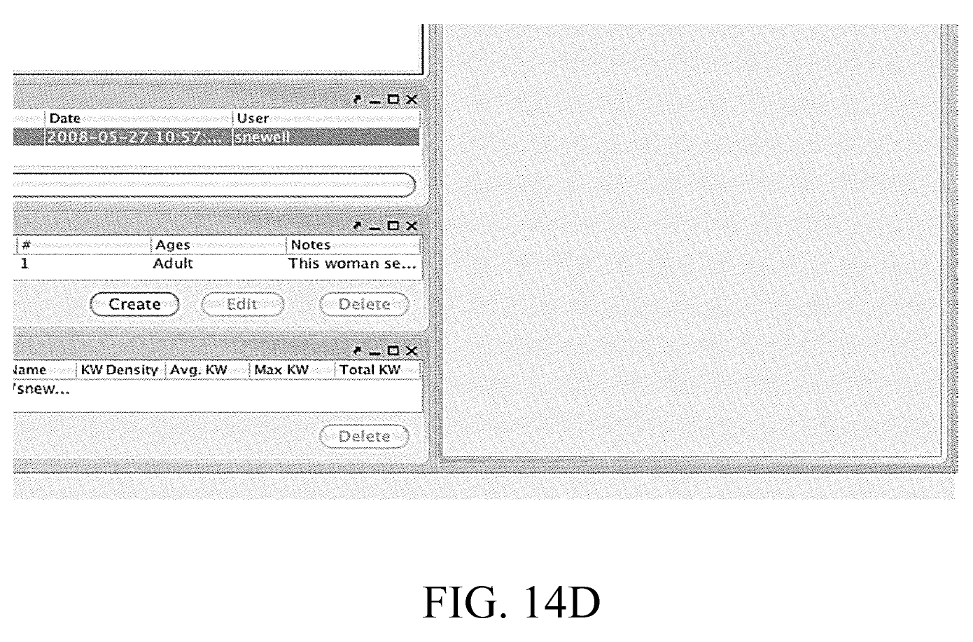

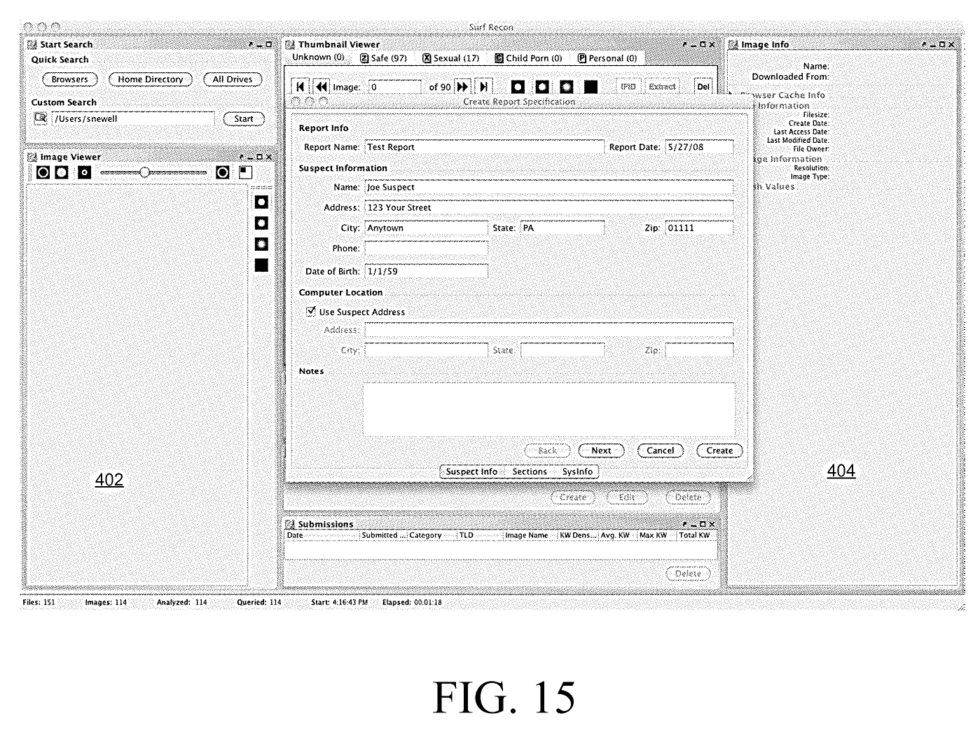

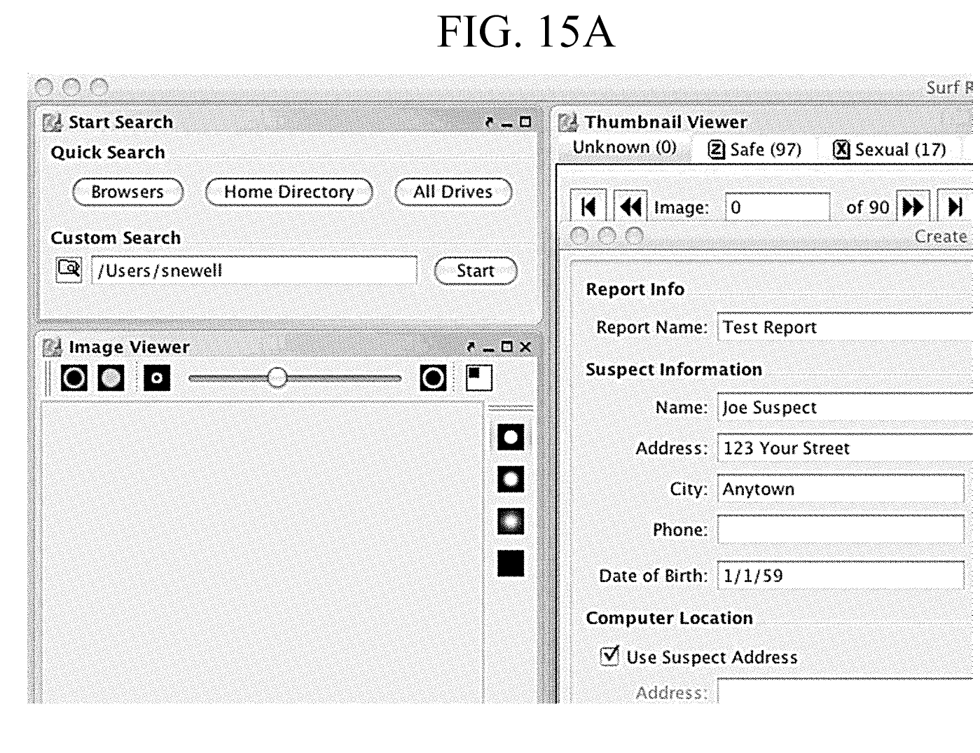

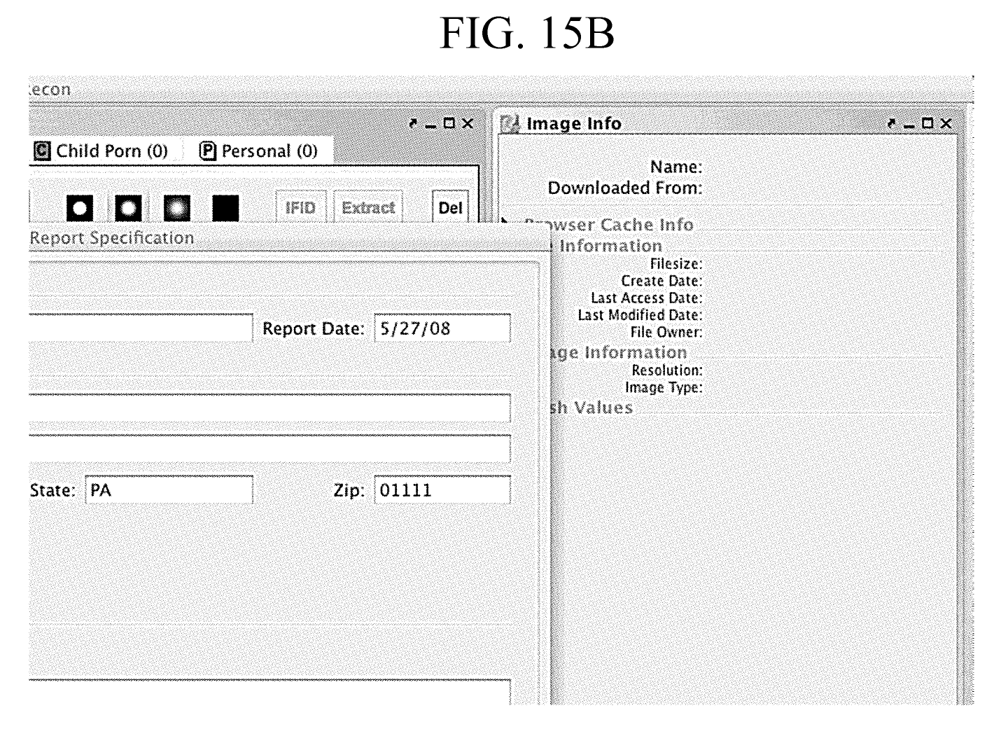

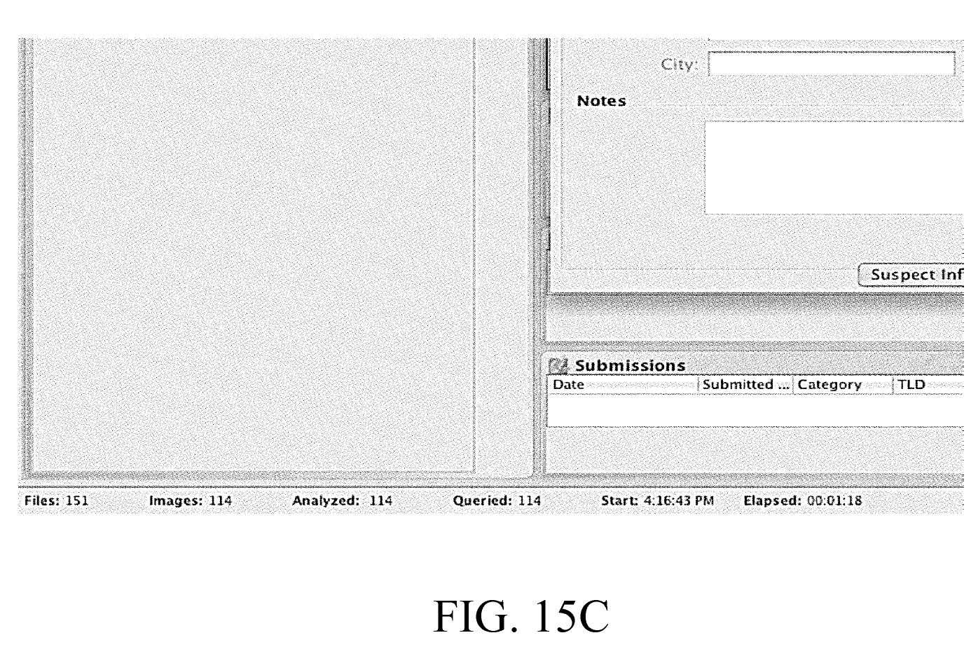

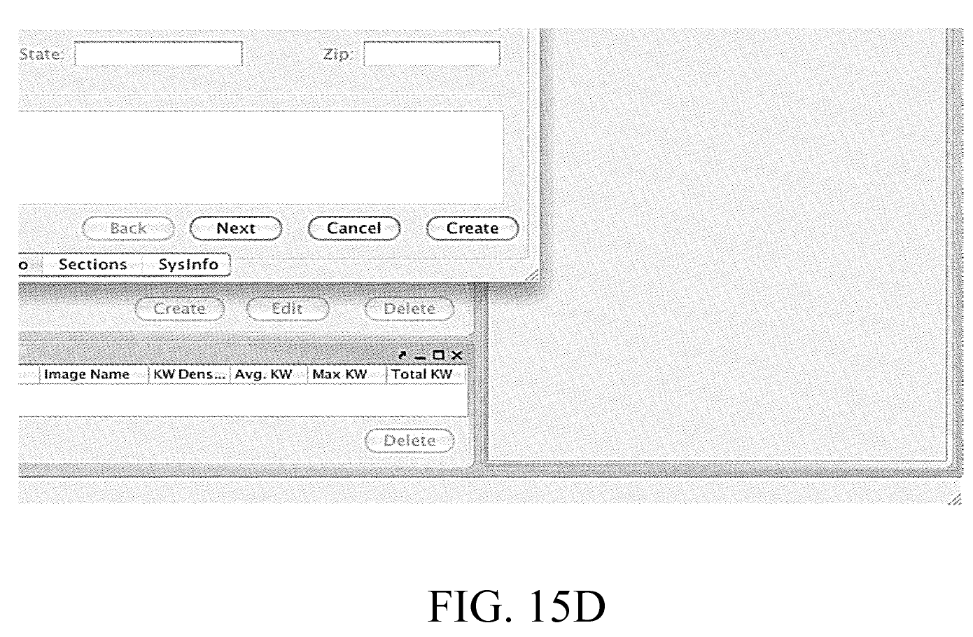

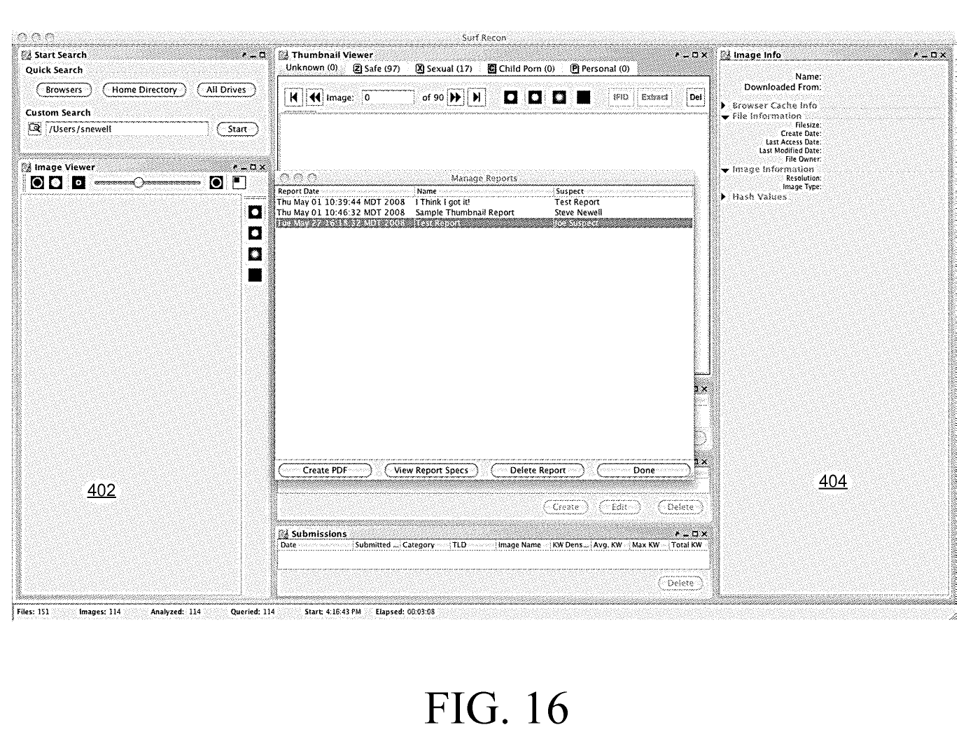

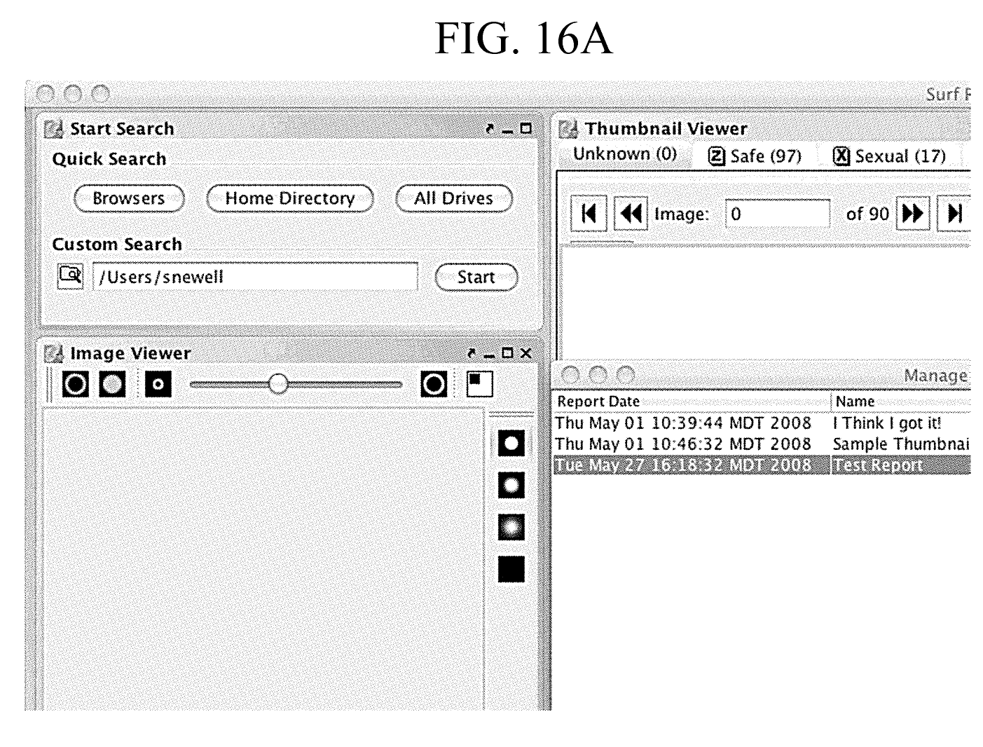

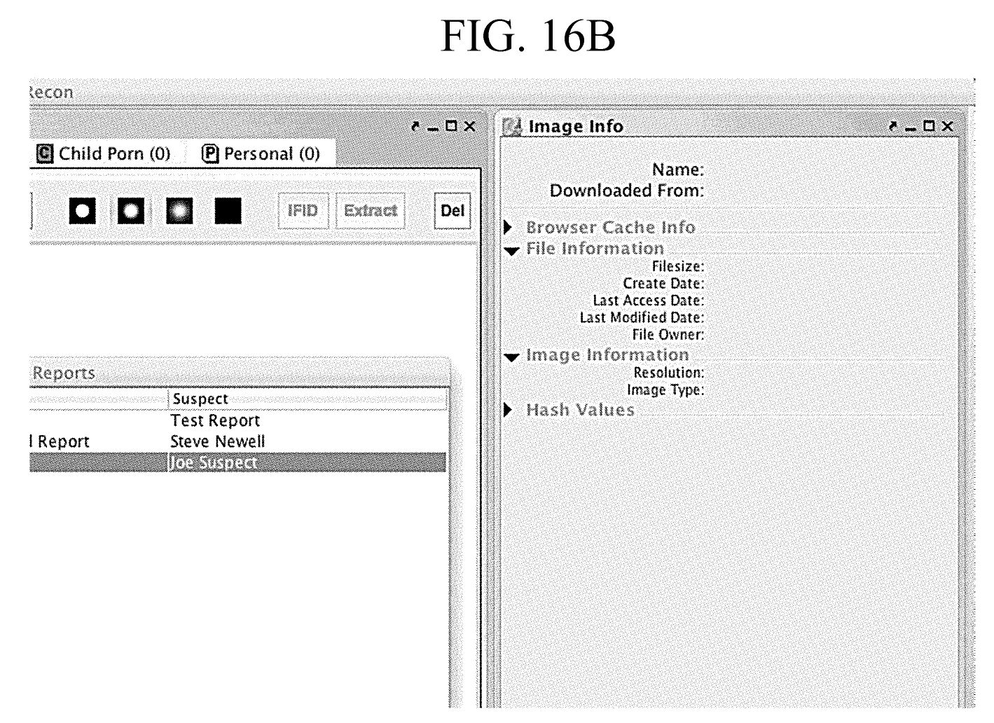

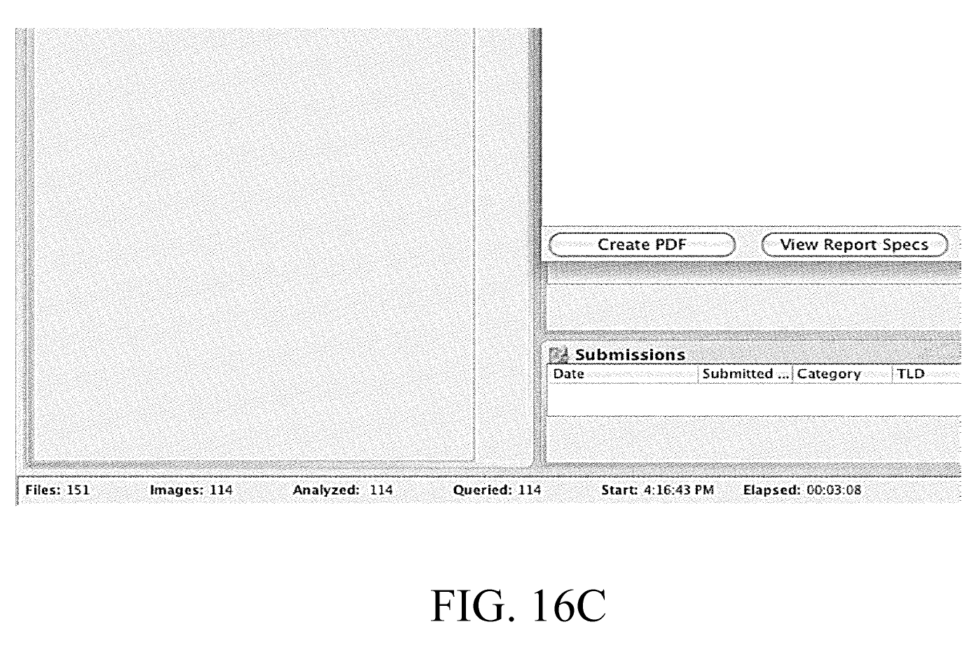

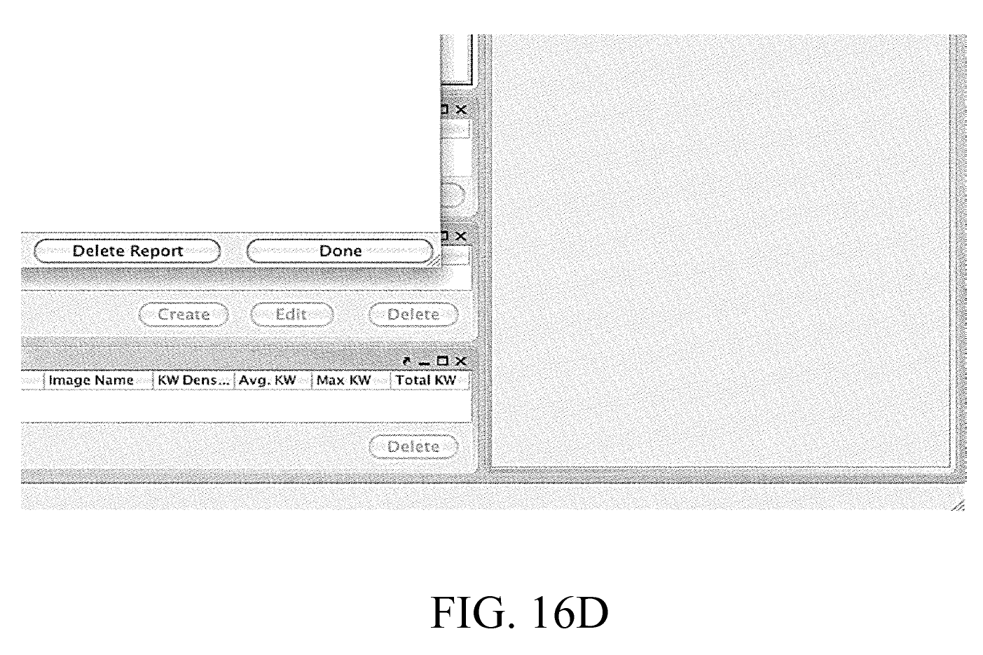

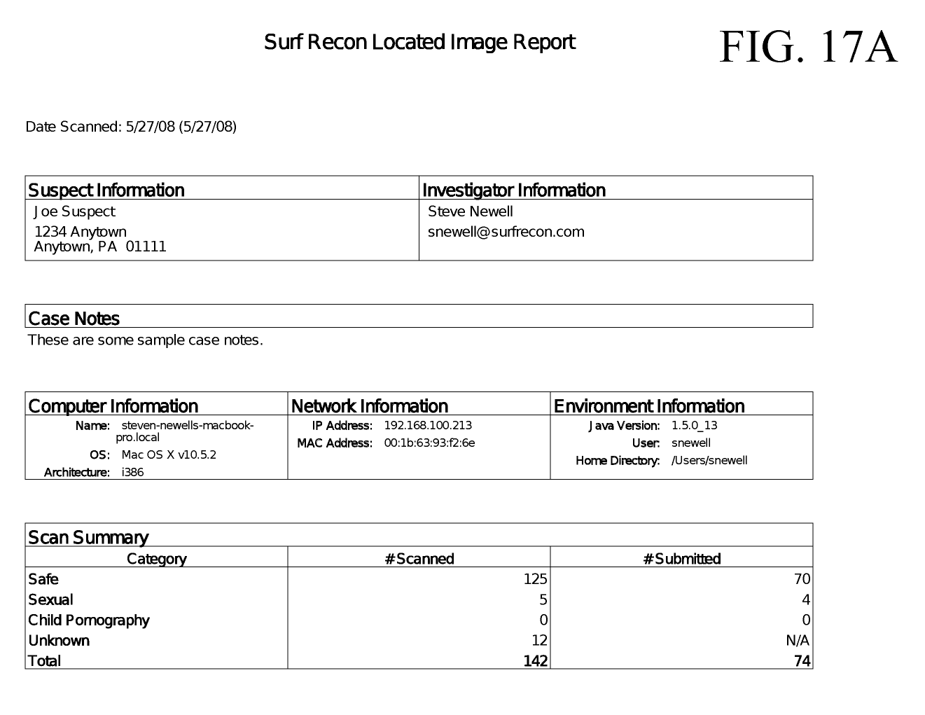

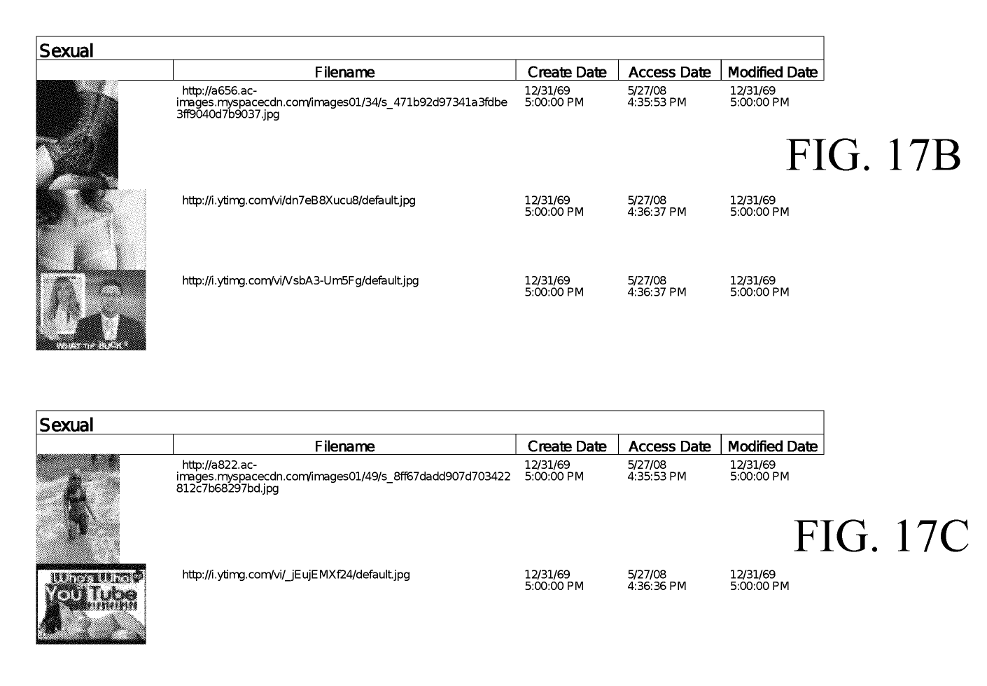

Shown in FIGS. 7A and 7B is an exemplary report of the exemplary scanner program, summarizing the product of a scanning and annotation operation. In the report the following information is provided: the date of the scanning operation, the suspect's information, the investigator's information, computer information on which the scanning operation was performed, the network address of the scanning computer, the computer environment of the scanning program. Furthermore, a scan summary is provided listing by category the number of images scanned and the number of images submitted to the categorization database. In this example, 125 images were considered safe, 70 of those images being newly categorized and submitted to the categorization database. Five images were considered of a sexual nature, and 12 were of an unknown nature, meaning that the user did not take the time to categorize these images. The exemplary report continues with a listing of image summaries for images that were placed in a suspect category, each summary including a thumbnail picture, a file name, and create, access and modify dates. Now it is to be remembered that the above scanning program and its report are merely exemplary, and no particular information, view, content, functionality or other feature are necessary.

It is also to be recognized that the features described above in relation to systems that create or use databases of image content characterization may be incorporated singly, or any number of these features may be incorporated into a single product, consistent with the principles and purposes disclosed herein. It is therefore to be recognized that the specific products and particular methods described herein are merely exemplary and may be modified as taught herein and as will be understood by one of ordinary skill, and the inventions are not limited to the particular products, techniques and implementations described herein.

What is claimed:

1. A computer-readable medium containing instructions for selectively rendering images according to categorization content, said medium comprising computer instructions executable to achieve the functions of:
accessing a store of informational content including images;
fetching images located in the store;
for fetched images, computing a fingerprint;
accessing a store of content categorizations, said accessing requesting a content categorization for a computed fingerprint;
receiving from the store in response to a request for a content categorization, a data object containing at least one content categorization;
making a determination as to whether an image is to be rendered based on a data categorization from the store using a fingerprint corresponding to the image;
if it is determined that an image should be rendered based on a categorization of that image, displaying the image to a person;
if it is determined that an image should not be rendered based on a categorization of that image, performing a non-rendering step.

2. A computer-readable medium according to claim 1, wherein the non-rendering step is to render a obfuscated copy of the image.

3. A computer-readable medium according to claim 1, wherein the non-rendering step is to omit rendering of the disallowed image.

4. A computer-readable medium according to claim 1, wherein the non-rendering step displays a message where the image would have appeared.

5. A computer-readable medium according to claim 1, wherein the non-rendering step displays a pre-selected background image or pattern.

6. A computer-readable medium according to claim 1, wherein said computer instructions are further executable to achieve the function of operating an HTML browser.

7. A computer-readable medium according to claim 1, wherein said computer instructions are further executable to achieve the function of displaying data from untrusted sources.

8. A computer-readable medium according to claim 1, where a determination is made as to whether an image should be rendered is based on a content category selected from the group consisting of sexual content, violence, nudity, and child pornography.

9. A computer-readable medium according to claim 1, wherein said computer instructions are further executable to achieve the functions of creating of submitting an image content categorization to the store of categorizations.

10. A system for selectively rendering images according to categorization content, comprising:
a display viewable by a person;
an image access facility functional to read a store of informational content including images;
a content categorization facility functional to read a database of image content categorizations;
a fingerprint computation facility functional to produce fingerprints from image data;
a rendering facility functional to display information retrieved through said image access facility on said display;
wherein said system is operable to receive a fingerprint from said fingerprint computation facility for an image obtained through said image access facility;
wherein said system, having received a fingerprint for an image from said fingerprint computation facility, is further operable to obtain a content categorization through said content categorization facility;
wherein said system, having obtained a content categorization for an image through said content categorization facility, makes a determination as to whether or not the image is appropriate to display;
wherein said system renders an image through said rendering facility where a corresponding appropriateness determination is positively made for the image; and
wherein said system takes a non-rendering step for an image where a corresponding appropriateness determination is negatively made.

11. A system according to claim 10, wherein said content categorization facility is functional to access a plurality of content categorization databases.

12. A system according to claim 11, wherein said content categorization facility is functional to select a content categorization database by a hash of a fingerprint.

13. A system according to claim 11, wherein said content categorization facility is functional to select a content categorization database by a hash of a fingerprint.

14. A system according to claim 10, wherein said content categorization facility is functional to access a distributed content categorization database.

15. A system according to claim 10, wherein said fingerprint computation facility uses a function having image modification immunity.

16. A system according to claim 10, wherein said system is further functional to submit an image content categorization to a database of image content categorizations.

17. A method of selectively rendering images according to categorization content, said method comprising the steps of:
accessing a store of informational content including images;
fetching images located in the store;
for fetched images, computing a fingerprint;
accessing a store of content categorizations, said accessing requesting a content categorization for a computed fingerprint;
receiving from the store in response to a request for a content categorization, a data object containing at least one content categorization;
making a determination as to whether an image is to be rendered based on a data categorization from the store using a fingerprint corresponding to the image;
if it is determined that an image should be rendered based on a categorization of that image, displaying the image to a person;
if it is determined that an image should not be rendered based on a categorization of that image, performing a non-rendering step.
